(19) United States
(12) Patent Application Publication
(10) Pub. No.: US 2025/0026554 A1
(43) Pub. Date: Jan. 23, 2025

(54) Storage Container Assembly Set with Optional Thermal Control for Food Products in Multiple Environments

(71) Applicant: Columbia Insurance Company, Omaha, NE (US)

(72) Inventors: Megan Shaffer, Addison, IL (US); Matt Krumm, Addison, IL (US); Zach Wilson, Addison, IL (US)

(21) Appl. No.: 18/778,871

(22) Filed: Jul. 19, 2024

Related U.S. Application Data
(60) Provisional application No. 63/527,691, filed on Jul. 19, 2023.

(51) Int. Cl. B65D 77/04; B65D 1/34; B65D 21/02; B65D 25/02; B65D 25/24; B65D 43/02; B65D 51/16; B65D 81/20; B65D 81/26

(52) U.S. Cl. CPC B65D 77/046; B65D 1/34; B65D 21/0233; B65D 25/02; B65D 25/24; B65D 43/0202; B65D 51/1683; B65D 81/2038; B65D 81/261; B65D 2543/00027; B65D 2543/00194; B65D 2577/043

(57) ABSTRACT

A storage container assembly set is disclosed for use with the safe storage and containment of food items in different environments. The storage container assembly set may include a plurality of storage containers that can hold the food items. The plurality of storage containers may have a storage container base and a storage container lid with optional components that may also be used with the assembled storage containers. In the assembled configuration, the storage container assembly set may include a tray to hold the plurality of storage containers. The tray may also first hold a plurality of cooling inserts that can contact the plurality of storage containers to keep the plurality of storage containers cool in higher temperature environments to help maintain the stability and freshness of the food items contained within the plurality of storage containers.

### CROSS-REFERENCE AND PRIORITY CLAIM TO RELATED PATENT APPLICATIONS

This US non-provisional patent application claims priority to U.S. Provisional patent application 63/527,691 filed Jul. 19, 2023, and titled “Storage Container Assembly Set with Optional Thermal Control for Food Products in Multiple Environments,” the entire disclosure of which is incorporated herein by reference.

### INTRODUCTION

Preparing and storing food items or prepared food items has always been essential to human survival. From digging deep earth cellars to access cooler underground ambient temperatures to smoking or curing meats and other perishables, storage and preparation of food items for storage has always been needed or employed. Advancement in food item storage and storage preparation are some of the most important advancements leading to human success and ultimately colonization of the entire planet. Without proper food item storage techniques and food item storage containers, human beings may not have risen to their current position within the global ecosystem.

Advancements in food storage and food storage container continue to evolve and develop to the needs of people. Additionally, environmental factors come greatly into play on possible food container designs and food storage options. For examples, those living in a hot desert climate must deal with the extreme heat and the consequences it may have on perishable food items if not properly treated or stored. Those living in remote arctic climates may have an easier time with overall preservation of food due to the chilling temperatures, but maybe deal with additional limitations on gathering, preparing, or even storing food reserves and raw material supplies and game may be low in such harsh climates.

Food storage containers continue to take different shapes and forms as well as advancements are made in the general industry. From simple clay pots and hand-woven baskets, food storage containers may be created with specific materials for specific needs. However, just because advancements have allowed for more complex materials to be used with food storage products that does not mean the consuming public has embraced such technology. Over time, it is clear that when it comes to food storage the consuming public gravitates towards easy-to-use designs, designs and functionality that successfully utilizes spacial requirements in their own homes, and functional pieces that have a benefit of multiple uses in different conditions.

The inventors envision such an assembly kit which can solve and address these issues, desires, and industry trends. The assembly kit disclosed by the inventors' functions as an easily operatable design that can be understood by the consumer after some initial understanding and set up. Furthermore, the assembly kit makes use of general spatial requirement constraints commonly encountered by consumers and allows them to utilize these constraints optimally in each a storage, preparation, and serving setting. Moreover, the assembly kit provides the consumer or end user with multiple possible configurations and functional options not present in known storage containers within the marketplace. Thus, the consumer or end user can adjust the overall assembly kit or just one storage container of the disclosed assembly kit to the desired use. Optional components not used or desired for use by the consumer and end user can also be easily stored in some embodiments with other components of the disclosed assembly kit. Additionally, the disclosed assembly kit has the ability to further control and maintain the desired temperature of food products or ingredients if needed by the consumer or end user. Thus, the disclosed assembly kit can allow for longer and safer use of food products in less optimal environmental conditions than general use storage containers readily available.

Further features and advantages of the disclosed embodiments, as well as the structure and operation of various elements of the disclosed embodiments, are described in detail below with reference to the accompanying drawings.

### BRIEF DESCRIPTION OF THE DRAWINGS

The accompanying drawings, which are incorporated in and form a part of the specification, illustrate the disclosed embodiments and, together with the description, serve to explain certain inventive principles. In the drawings:

FIG. 1 illustrates a perspective view of an example storage container assembly set in accordance with an embodiment of the disclosure.

FIG. 2 illustrates an exploded perspective view of the example storage container assembly set viewed in FIG. 1 in accordance with an embodiment of the disclosure.

FIG. 3 illustrates a perspective view of an example storage container that may be part of the storage container assembly set in accordance with an embodiment of the disclosure.

FIG. 4 illustrates an exploded perspective view of the storage container that may be part of the storage container assembly set viewed in FIG. 1 as disassembled components in accordance with an embodiment of the disclosure.

FIG. 5A shows a top-down perspective view of a storage container base that may be part of the storage container assembly set in accordance with an embodiment of the disclosure.

FIG. 5B shows a bottom-up perspective view of a storage container base that may be part of the storage container assembly set in accordance with an embodiment of the disclosure.

FIG. 6A shows a top-down perspective view of a drainage shelf that may be used with the storage container that may be part of the storage container assembly set in accordance with an embodiment of the disclosure.

FIG. 6B shows a bottom-up perspective view of a drainage shelf that may be used with the storage container that may be part of the storage container assembly set in accordance with an embodiment of the disclosure.

FIG. 7A shows a top-down perspective view of a divider that may be used with the storage container that may be part of the storage container assembly set in accordance with an embodiment of the disclosure.

FIG. 7B shows a bottom-up perspective view of a divider that may be used with the storage container that may be part of the storage container assembly set in accordance with an embodiment of the disclosure.

FIG. 8A shows a top-down perspective view of a storage container lid that may be used with the storage container that may be part of the storage container assembly set in accordance with an embodiment of the disclosure.

FIG. 8B shows a bottom-up perspective view of a storage container lid that may be used with the storage container that may be part of the storage container assembly set in accordance with an embodiment of the disclosure.

FIG. 9A shows a top-down perspective view of a vent slider of the storage container lid that may be used with the storage container that may be part of the storage container assembly set in accordance with an embodiment of the disclosure.

FIG. 9B shows a bottom-up perspective view of a vent slider of the storage container lid that may be used with the storage container that may be part of the storage container assembly set in accordance with an embodiment of the disclosure.

FIG. 9C shows an attached view of a vent slider of the storage container lid that may be used with the storage container that may be part of the storage container assembly set in accordance with an embodiment of the disclosure.

FIG. 10A shows a top-down perspective view of a tray that may be used to contain a plurality of storage containers that may be part of the storage container assembly set in accordance with an embodiment of the disclosure.

FIG. 10B shows a bottom-up perspective view of a tray that may be used to contain a plurality of storage containers that may be part of the storage container assembly set in accordance with an embodiment of the disclosure.

FIG. 11A shows a top-down perspective view of a cooling insert that may be used with the tray that may be part of the storage container assembly set in accordance with an embodiment of the disclosure.

FIG. 11B shows a bottom-up perspective view of a cooling insert that may be used with the tray that may be part of the storage container assembly set in accordance with an embodiment of the disclosure.

### DETAILED DESCRIPTION OF EXAMPLE EMBODIMENTS

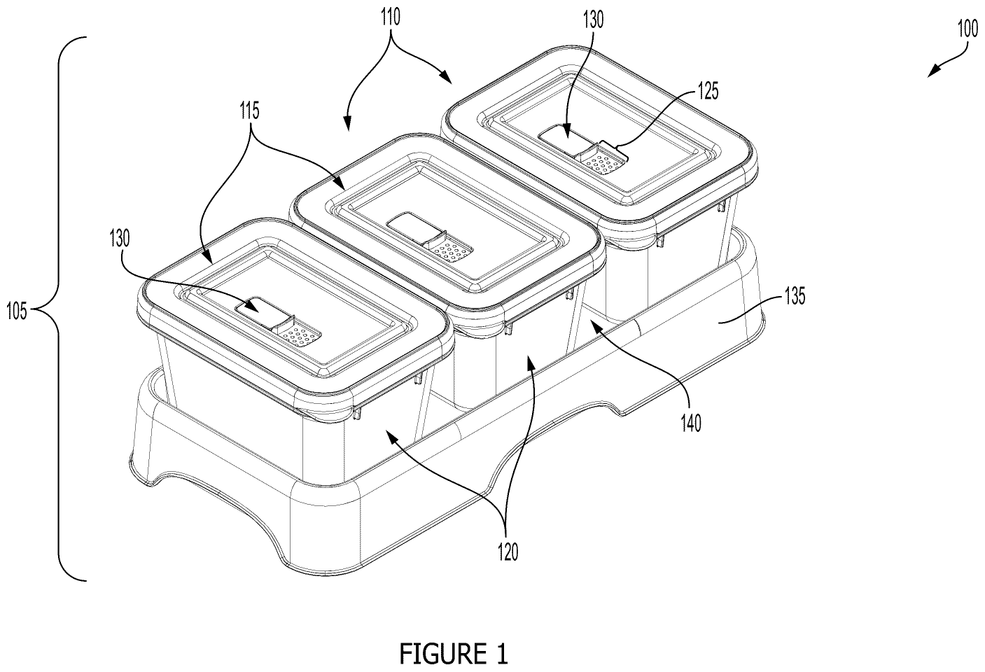

Referring to the accompanying drawings, FIG. 1 illustrates an example storage container assembly set 100. The storage container assembly set 100 of FIG. 1 is viewed in the example assembled configuration 105. The example storage container assembly set 100 shown in FIG. 1, is viewed having a plurality of storage containers 110 used in the disclosed embodiment. While the example shows use of three storage containers creating the plurality of storage containers 110 it should be understood that different numbers of storage containers can be used based on the size and shape of the storage containers among other considerations. Furthermore, additional components that may be used with the plurality of storage containers 110 may be present and enclosed within each of the storage containers in this assembled configuration 105.

The plurality of storage containers 110 may also contain or use a plurality of storage container lids 115 in the assembled configuration 105 of the storage container assembly set 100. The plurality of storage container lids 115 may snap fit seal with a plurality of storage container bases 120 to create the plurality of storage containers 110. Of course, other possible sealing arrangements between the plurality of storage container lids 115 and the plurality of storage container bases 120 may be possible and are envisioned. The plurality of storage container lids 115 has a unique design and functional configuration that will be discussed in more detail further below. Present within each lid of the plurality of storage container lids 115 may be a plurality of venting holes 125. The plurality of venting holes 125 allows for air to flow into and out of the each of the storage containers if desired by the user. However, if air flow or a more vacuum seal is recommended for the stored food item or prepared food product housed within the plurality of storage containers 110, the plurality of storage container lids 115 offer a sealing mechanism to limit or adjust airflow. As viewed in FIG. 1, the upper surface of the plurality of storage container lids 115 may have a vent slider 130. The vent slider 130 may be contained within the storage container lid of each of the plurality of storage containers 110. Further, there may be a plurality of venting options available for storage container lids having a vent slider 130. Thus, the end user can use this plurality of venting options to determine and decide how much or how little air flow is desired to enter a specific storage container of the plurality of storage containers 110.

Also viewed in FIG. 1 is a tray 135 that may be used to house and hold the storage containers in the assembled configuration 105 of the storage container assembly set 100. The tray 135 viewed here in this example embodiment is designed to hold and accommodate three storage containers of the plurality of storage containers 110. It should be understood that along with the size and shape of the storage containers, the tray 135 as well can have a different size and shape allowing for greater or fewer number of storage containers to be held within the tray 135 in the assembled configuration 105.

Below the plurality of storage containers 110 and located and housed in a bottom portion of the tray, a plurality of cooling inserts 140 may be present. In the assembled configuration 105 viewed in FIG. 1, the plurality of cooling inserts 140 may only be partly visible between each of the storage containers. In some envisioned use embodiments, the plurality of cooling inserts 140 may be previously cooled or frozen before placement within the bottom portion of the tray. When each storage container is placed on top of the plurality of cooling inserts 140, each storage container may have leg extensions that help positionally secure it on top of and in contact with the upper surface of any contacted plurality of cooling inserts. In this assembled configuration 105, the plurality of cooling inserts 140 may transfer cooling energy through this connection to the contacted storage containers of the plurality of storage containers 110. This contact allows for the cooling energy transfer from the plurality of cooling inserts 140 to the plurality of storage containers 110 through each storage container bottom surface. This in turn may cool or help maintain a cooler temperature of possible ambient air sealed within a respective storage container in contact with the plurality of cooling inserts 140. In other possible scenarios, a stored food item or prepared food product may be present and in contact with the interior surface of the storage container. Here, the storage container surface may transfer the cooling energy through the storage container surface material to the stored food item or prepared food product to keep the stored food item or prepared food product at a desired temperature.

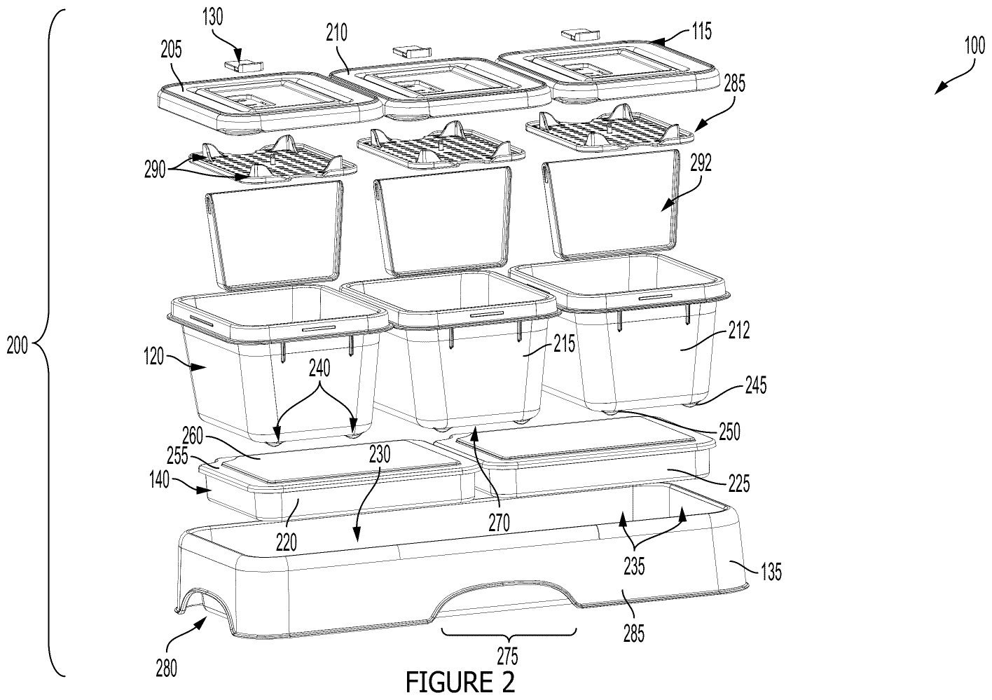

Turning now to FIG. 2, the example storage container assembly set of FIG. 1. Is viewed in an exploded view showing the multiple components of the storage container assembly set. The exploded view can also be considered to be a disassembled configuration 200 of the storage container assembly set. Generally, the disassembled configuration of the storage container assembly set would be a position other than interconnected use of the multiple components of the plurality of storage containers 110 with use of the tray. Use of the plurality of cooling inserts 140 may always be optional and are not required for achieving an assembled configuration.

FIG. 2 shows many of the same components viewed and described above with the disclosure of FIG. 1. At the top of FIG. 2, a plurality of vent sliders are viewed dissembled from their respective locations on each of the plurality of storage lids. When assembled and attached to the plurality of storage lids, the plurality of vent sliders can help control or limit access of outside ambient air that may enter the plurality of assembled storage containers based on the desired needs and use of the end user. In an unattached position with a corresponding storage container base, a first storage container lid 205 can also nest together and stack upon a second storage container lid 210. Thus, in this type of configuration the plurality of storage container lids can be stacked and easily stored where appropriately desired by the end user. Initially skipping over the next two viewed components, which will be discussed later, and further below the plurality of storage lids a plurality of storage container bases may be present. The plurality of storage container bases are designed and capable of housing food items or prepared food items for storage. When the plurality of storage lids attach to their respective plurality of storage container bases the plurality of storage containers are formed. In an unattached position with a corresponding storage lid, a first storage container base 212 can also nest within and stack upon a second storage container base 215. Thus, in this type of configuration the plurality of storage container bases can be stacked and easily stored where appropriately desired by the end user.

Below the plurality of storage container bases the plurality of cooling inserts are viewed. As seen in FIG. 2, the example embodiment shows the use of a first cooling insert 220 and a second cooling insert 225 to create the plurality of cooling inserts. The plurality of cooling inserts are generally larger in size and surface area than a respective storage container when it is assembled. In the assembled configuration, the plurality of cooling inserts may be used. When chosen for use, the plurality of cooling inserts can rest and nest within a tray interior 230 of the tray and be bounded by a plurality of tray interior side walls 235 of the tray. Once placed in this position, the plurality of storage containers in either an assembled form or solely the plurality of storage container bases may also be placed into the tray. A plurality of surface legs 240 may generally be present and extend downward from each storage container base of the plurality of storage container bases or the assembled plurality of storage containers. For example, the plurality of surface legs present on each storage container base may include at least four surface legs, a first surface leg 245, a second surface leg 250, a third surface leg (not shown), and a fourth surface leg (not shown), but other positional locations or surface leg numbers or surface leg designs are possible. The plurality of surface legs on each storage container are used to help guide the storage container into the correct resting position on any contacted cooling insert that may be present within the tray. Each cooling insert of the plurality of cooling inserts may have a first top surface 255 and a second top surface 260 on each cooling insert. The first top surface is viewed and envisioned to be slightly lower than the second top surface on each cooling insert. Further, the first top surface of the cooling insert may circumnavigate the second top surface of the cooling insert on one side while creating a top edge 265 of the cooling insert on the other side. Both the first top surface and the second top surface are generally flat and planer designs, but other possible configurations are envisioned. As stated above, the second top surface of the cooling insert is higher than the first top surface of the cooling insert. When the plurality of storage container or the plurality of storage container bases are to be placed within the tray already holding the plurality of cooling inserts, the differentiation between the first top surface and the second top surface of each respective cooling insert has additional importance. The plurality of surface legs that may be present on each storage container base, whether alone or as an assembled storage container, may rest and contact the first top surface of the plurality of cooling insert. It should be understood and appreciated that the plurality of cooling inserts used and secured within the tray are to have common locations of their respective first top surface and second top surface. While the plurality of surface legs contact the first top surface of any cooling insert based on placement within the tray, a base bottom wall 270 of the storage container base contacts and may rest upon the second top surface of the any respective cooling insert. This contact between the second top surface of the plurality of cooling inserts and exterior bottom surface of any of the plurality of storage container bases allow for the most optimal and ideal amount of cooling energy transfer between the cool, cold, or frozen plurality of cooling inserts and whatever food item or prepared food products are housed within the plurality of storage container bases. Moreover, when the plurality of surface legs of any storage container base contacts the first top surface of any cooling insert placed within the tray, movement is minimized. As the length, width, and surface area of first top surface of the cooling insert much smaller than the length, width, and surface area of the second top surface of the cooling insert the first top surface can be thought of as a small channel. Placement of the plurality of surface legs of any storage container base on the top surface may allow for slight minimal movement in a width direction but the presence of the plurality of surface legs bounds and confines any storage container on width movement by the second surface of the cooling insert on one end and the interior side wall of the tray on the other end. Thus, the storage container base is relatively secure when placed inside the tray where the exterior bottom surface of the storage container maintains maximum contact with the second top surface of the cooling inserts upon which it may rest.

Further, while movement in the width direction of the storage container base may be bounded in the width direction when placed within the tray in the assembled configuration of the storage container assembly set, lengthwise movement of the storage container base is possible based on the common configuration and envisioned design of each first top surface and second top surface of the cooling inserts that are used to create the plurality of cooling inserts. When assembling the storage container assembly set, a first storage container base either alone or as an assembled storage container may be first placed within the tray to rest on the plurality of cooling inserts. Often times, the end user may want to adjust or reconfigure the positioning of the storage container base when additional components such as a second or third storage container base is added to the storage container assembly set and placed within the tray in the assembled position. Thus, the end user can manually slide the storage container base first placed within the tray and resting on the plurality of storage container inserts to the desired position lengthwise. While sliding the storage container base first placed within the tray, the storage container base can move with its plurality of surface legs along the first top surface of any cooling insert it may contact while allowing the bottom exterior surface of the storage container base to remaining in contact with a plurality of cooling inserts to keep and maintain the cooling energy transfer that may be needed for the food items or prepared food products present within the storage container base.

Below the plurality of cooling inserts, the tray is viewed in FIG. 2. As explained above, the tray is available to the end user to hold and secure multiple storage container bases, alone or assembled as a storage container, for quick and efficient movement of multiple food items or multiple prepared food products housed within the multiple storage container bases. In some assembled configurations, the plurality of cooling inserts may be present if temperature control is desired for the multiple food items or multiple prepared food products housed within the multiple storage container bases. Other times, the multiple storage container bases, alone or assembled as a storage container, can be placed directly into and housed by the tray. To ease the movement of multiple storage containers placed into the tray in either of the above fashions, the tray may have at least one handhold location and may include a plurality of handhold locations 275. The tray viewed in FIG. 2, for example may contain four such handhold locations, a first handhold location 278, a second handhold location 280, a third handhold location (not shown), and a fourth handhold location (not shown). These handhold locations may be present on each exterior side wall of the plurality of exterior side walls 282 of the tray to allow the user to easily grip or maneuver the tray from any direction available and accessible.

Below each of the plurality of storage container lids, is a drainage shelf 285. The drainage shelf may be used or placed within a storage container base of the plurality of storage containers. When placed inside of the storage container base, the drainage shelf may rest on a plurality of drainage shelf legs 290. The plurality of drainage shelf legs extend downward from the drainage shelf and may contact the bottom interior surface of the storage container base to spatially align the drainage shelf a predetermined distance above the bottom interior surface of the storage container base. When not in use, the drainage shelf may be attached to a storage container lid for storage purposes. The drainage shelf is an optional component available to the end user. For example, the drainage shelf may be used with food items or prepared food products that have been recently cleaned or rinsed to collect and contain excess water or solution at the bottom of the storage container base or when the food items or prepared food products may have a high moisture content, be prone to leakage or melting, or if seasoning or further cooking related preparations or adjustments are made to the food items or prepared food products to collect and remove any excess or undesired liquid runoff from the food items or prepared food products.

Below the drainage shelf, a divider 292 is viewed in FIG. 2. The divider, like the drainage shelf, is also an optional component that may be used within the storage container base. It should further be understood that the divider can be used within the storage container base with the drainage shelf attached in the storage position in connection with the storage container lid if the storage container lid is to be secured to the storage container base to form an assembled storage container. In other envisioned embodiments, the divider may be of a smaller size to also additionally be used with the drainage shelf placed in the use position at the bottom of the storage container base. The divider may be used when it is desired by the end user to further compartmentalize or split up the internal storage area of the storage container base interior into multiple positions so that more than one possible food item or prepared food product can be present and separated within the same storage container base. While the divider viewed in FIG. 2 can separate the storage container interior into a first storage interior position and a second storage interior position, it should be understood, and it is envisioned by the inventors that additional designs or configurations may be present or can be used with the storage container base to separate the interior into more storage interior positions.

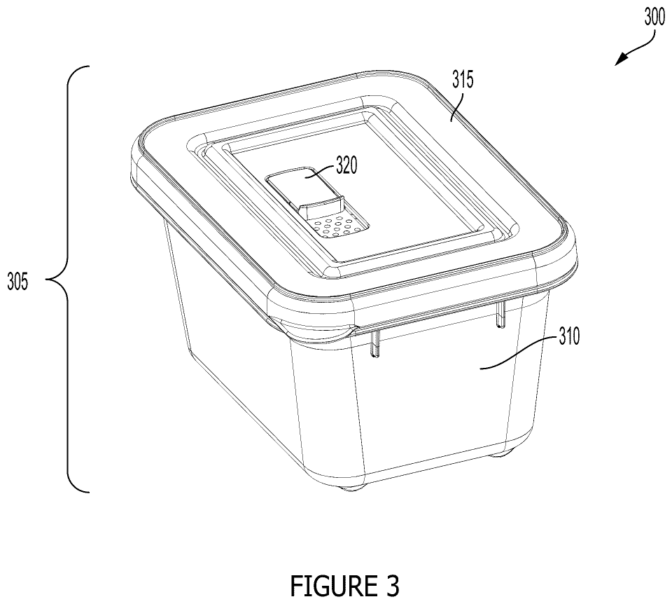

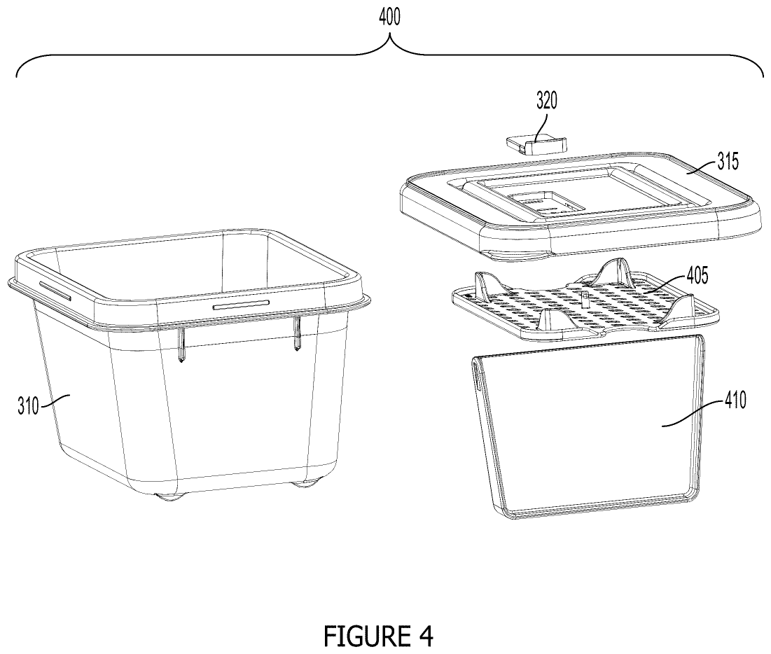

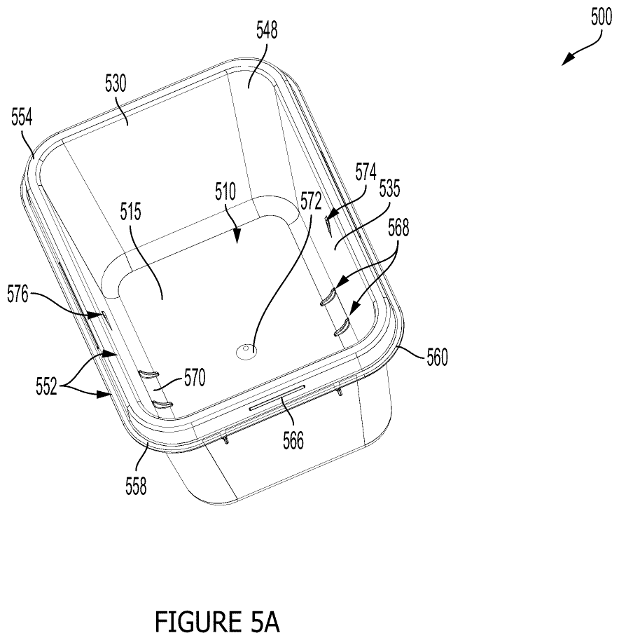

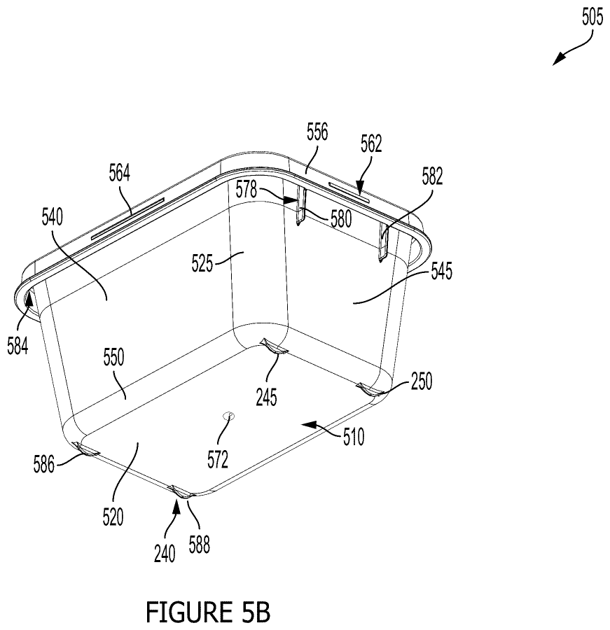

FIG. 3 shows an individual storage container 300 in an assembled position 305. FIG. 4 shows the same or similar individual storage container 300 viewed in an exploded position 400. The individual storage containers as viewed in FIG. 3, or at least the storage container base viewed in FIG. 4, can be used with the tray and the plurality of cooling inserts to create the storage container assembly set in the assembled configuration. The individual storage containers or the individual storage container base can also be used in and of itself to help contain and keep food items or prepared food products safe and secure. In this mode of operation, the storage container assembly set is in the disassembled configuration and only particular components of the storage container assembly set may be used as desired by the user. FIG. 3 shows an individual storage container having a storage container base 310, a storage container lid 315, and a vent slider 320 in the assembled position. Additional components like a drainage shelf 405 and a divider 410 may also be present in this design in some configurations of the drainage shelf and divider components, but those would be housed within the interior of the storage container base with the lid secured. Each the drainage shelf, the divider, and the vent slider can be viewed in FIG. 4 in a disassembled position. FIGS. 5-9 will address each of these individual components that can and may be included with use of each storage container of the storage container assembly set in either the assembled configuration or individually alone as part of an individual storage container in the disassembled configuration of the storage container assembly set.

Turning now to FIGS. 5A and 5B, a storage container top-down perspective view 500 (FIG. 5A) and a storage container bottom-up perspective view 505 (FIG. 5B) of a storage container base that may be part of the storage container assembly set or an individual storage container is shown. The storage container base may be created by any type of material suitable and safe to store food items or prepared food products. For example, the storage container base may be created with the use of food grade plastics, food grade polymer-based materials, or the like that are rated safe for food item or food product contact. The storage container base is envisioned to be continuous and may be made my mold injected material to create such a continuous design, but other manufacturing options are possible based on the configuration and materials used to create the storage container base. Additionally, the storage container base is envisioned to generally be constructed of dishwasher safe materials such that the storage container base can easily be washed within dish washing machines for simple clean up and to remove any remaining food items or prepared food products after operational use. In other embodiments, the storage container base may be made out of food grade metals or metallic alloys or the like. For dry food use, the storage container may also be created with wooden type materials, or other possible materials. Additionally, in some instances the storage container base may be created by a combination of materials. Further, the materials used to create the storage container base may have insulative properties or allow for easy transmission of thermal heating or cooling into the storage container base to adjust or maintain the temperature of the food items or prepared food products held within the storage container base as desired by the end user. In some instances, only a base bottom wall 510 having an interior bottom wall surface 515 or an exterior bottom wall surface 520 may be made of such thermal properties to help aid in the cooling, heating, or maintenance of temperature of any food items or prepared food products contained or stored within the storage container base and in contact with the bottom wall of the storage container base. In yet other possible envisioned examples, the bottom wall of the storage container base may be made of the same material as the remaining portions of the storage container base, but may also contain a thermal coating on either or both the interior bottom wall surface or exterior bottom wall surface to help aid in the cooling, heating, or maintenance of temperature of any food items or prepared food products contained or stored within the storage container base and in contact with the interior bottom wall surface of the bottom wall of the storage container base.

Overall, the storage container base is generally rectangular in shape, but is not envisioned in the example use to be completely rectangular and box shape. The storage container base may have a plurality of side walls 525 that rise up from a bottom wall of the storage container base. For example, and viewed in FIGS. 5A and 5B, the storage container base many have four side walls, a first side wall 530, a second side wall 535, a third side wall 540, and a fourth side wall 545, with opposing side walls having the same or similar design or configuration. Of course, it is envisioned that other possible shapes and designs of the storage container base with multiple side walls and a bottom wall are possible and can be used with the overall storage container assembly set. The connection between the plurality of side walls and the bottom wall may be rounded on both the interior and exterior surfaces of the storage container base. Further, a side wall connection 548 between a first side wall to a second side wall of the plurality of side walls may also be rounded on both the interior and exterior surfaces of the storage container base. Two side walls of the plurality of side walls may be longer in length than the two other side walls of the plurality of side walls as viewed in the Figures. This shape is used to match both the design of both the plurality of cooling inserts and the tray that can be used in storage container assembly set. As the side walls rise from the base bottom edge 550 formed by the connection of the bottom wall to the plurality of side walls, each side wall may angle slightly outward away from the interior volume area of the storage container base. Thus, the bottom edge of the storage container base may have a lower perimeter measurement value that is less than a base top edge 552 of the storage container base which may have a higher perimeter measurement value. Additionally, the outward sloped nature of the storage container base overall allows for multiple storage container bases to nest within one another for easy storage when the storage container base, storage containers, or storage container assembly set is not in use.

The top edge of the storage container base may then continue horizontally outward a short, predetermined distance to create a first base top edge surface 554. The first storage container base top edge surface may then curl back downward and travel a second short, predetermined distance to create a base side edge surface 556. After the storage container base side edge surface has traveled the second predetermined distance downward, the storage container base side edge surface may then once again travel horizontally outward a third short, predetermined distance to create a second base top edge surface 558. The second storage container base top edge surface then terminates in an ultimate edge 560 of the storage container base wherein the thickness is determined by the material and size of the overall top edge of the storage container base made in this matter.

The configuration of the overall top edge of the storage container base is to circumnavigate all of the plurality of side walls from which it extends and is attached. On each area of the storage container base side edge surface that corresponds to a side wall of the plurality of side walls, a plurality of base attachments 562 may be present. For example, and viewed in FIGS. 5A and 5B, there are four side walls for the storage container base so four base attachments, a first base attachment 564, a second base attachment 566, a third base attachment (not shown) (having the same or similar design of the first base attachment 564), and a fourth base attachment (now shown) (having the same or similar design of the second base attachment 566), may be present to create a plurality of base attachments. Each base attachment of the plurality of base attachments may be generally centered along the length of its corresponding side wall of the storage container base or generally centered along the length of the storage container base side edge surface that corresponds to a particular side wall of the storage container base. Each base attachment of the plurality of base attachments may also be generally centered along the width of the storage container base side edge surface that corresponds to a particular side wall of the storage container base. Each base attachment of the plurality of base attachments may be a long linear protrusion that extends outward and away from the storage container base side edge surface representative of each side wall of the storage container base. Further, the linear length of each base attachment of the plurality of base attachments may be adjusted based on the length of the corresponding side wall where the base attachment may be present. For the side walls that are longer in length, the corresponding base attachment may be longer than the length of a base attachment corresponding to a side wall of shorter length. Thus, the length of each base attachment is determined by the length of each side wall corresponding to its position. For example, and viewed in FIGS. 5A and 5B, the front and back side walls have shorter base attachments of a similar length while the left and right-side walls have longer base attachments of a similar length.

The overall top edge of the storage container base may be of a lesser thickness material wise than the bottom wall and the plurality of side walls of the storage container base and should be pliable and deformable when manipulated by the end user. While the overall top edge of the storage container base is pliable and deformable, once it is deformed or moved from its resting configuration it will quickly return to the resting configuration. Thus, the overall top edge of the storage container base can easily fit and accommodate a storage container lid to be removably attached to the overall top edge of the storage container base. In doing so, the user may manipulate or deform particular locations of the storage container base side edge surface near one or more of the base attachments to fit the storage container lid onto the overall top edge and below the plurality of base attachments. In some configurations, the storage container lid may also have a plurality of lid attachments that extend from the fitting area onto the overall top edge of the storage container base. Here, manipulation by the end user of the storage container base side edge surface near one or more of the base attachments allows for the corresponding plurality of lid attachments to fit on and over the plurality of base attachments on the storage container base side edge surface. In most envisioned use cases, when the storage container lid is in the sealed position with the storage container base, the plurality of lid attachments are located below the plurality of base attachments. Thus, upward force on the storage container lid along may not be enough to remove the storage container lid from the storage container base due to the contact and friction of the snap fit between the plurality of lid attachments and plurality of base attachments. Further, to efficiently and effectively remove the storage container lid from the sealing position on the storage container base the user may manipulate the pliable and deformable nature of the storage container base side edge surfaces near one or more of the base attachments to allow for the corresponding plurality of lid attachments to pass over the plurality of base attachments on the storage container base side edge surface so that the storage lid container can be easily removed.

The storage container base may also have a plurality of alignment guides 568 present. The plurality of alignment guides may be located on the interior surface of the storage container base and extend outward a small distance. Locationally, this plurality of alignment guides may be present at or near the bottom to side wall connection 570 of the bottom wall and at least one side wall of the storage container base. As FIGS. 5A and 5B show the connection between the bottom wall and the plurality of side walls to be rounded, the plurality of alignment guides may also be rounded and give off a semicircular shape, but other configurations and designs are possible based on the meeting point of the plurality of side walls and the bottom wall. The plurality of alignment guides may also be centrally located within the interior volume area of the storage container base. The central location may be the central location of the plurality of side walls of the storage container base that are the longest in length. However, it should be understood that other locational positions on these longest side wall lengths or even on the shorter side wall lengths are possible and envisioned.

The plurality of alignment guides may be spaced to accommodate the divider for use within the interior of the storage container base. When placed in the storage container base, the divider may be positioned between the alignment guides to help secure and hold the positional placement of the divider. As such, the plurality of alignment guides should be spaced just far enough apart lengthwise to accommodate and contain the entire width of the overall divider shape to be secured by the plurality of alignment guides. To further secure the divider in place, a divider protrusion 572 may be located on the interior surface of the bottom wall. The central divider protrusion may extend slightly upward and away from the surface of the bottom wall. The central divider protrusion may be circular in shape and designed to find a corresponding recess on the divider to be used within the storage container base. Of course, other shapes of the central divider protrusion are possible and envisioned along with such corresponding recesses on the divider. The central divider protrusion may also centrally align between the plurality of alignment guides where the divider may be placed. The central divider protrusion may be centered both in length and width to the corresponding divider shape so that when the divider is contained within the plurality of alignment guides it will also fit over and on the central divider protrusion.

Additionally, a plurality of divider tabs 574 and 576 may be present on the storage container base. The plurality of divider tabs may be present on one or more side walls of the storage container base and correspond to the locational positioning of the central divider protrusion on a horizontal access. Thus, the plurality of divider tabs may be present on the same side walls where the plurality of alignment guides are present and may be centered within the length of the space between the corresponding plurality of alignment guides present on that side wall. As seen in FIGS. 5A and 5B, the plurality of divider tabs may include two tabs, a first divider tab 574, a second divider tab 576, centered between the plurality of alignment guides on each side wall. However, it should be understood and envisioned that more or less divider tabs may be used depending on the configuration of the divider to be used with the storage container base. Each of the divider tabs of the plurality of divider tabs may be locationally present on the upper interior portion of the whatever side wall contains at least one of the plurality of alignment guides. In FIGS. 5A and 5B, divider tabs are located on both the right and left side walls on the upper portion of the side walls. The divider tabs may extend outward from and be part of the corresponding side wall where it is present. The divider tabs viewed in FIGS. 5A and 5B may be rectangular in shape, but other configurations and designs are envisioned. Each divider tab may have a top end and a bottom end. The outward protrusion length of the bottom end may be less than that of the top end. As the sidewalls of the storage container base generally angle outward from the bottom wall to the overall top edge, the divider tabs may mimic this shape to an extent. When the bottom end of the divider tab starts, the divider tab may be on the same outward slope as its side wall of the storage container base. However, as the side wall of the storage container base continues to slope outward away from the bottom wall, the divider tab may continue upward towards the top end of the divider tab in a straight vertical line. Thus, the overall appearance of each divider tab looks to the casual observer to be a gradually increasing protrusion length from the side wall into the interior of the storage container base as the divider tab travels upwards from the bottom end to the top end. When the divider is placed into the storage container base, and placed between the plurality of alignment tabs, the divider is further secured by this plurality of divider tabs. The divider may have a corresponding recess on each end of the dividers to fit over and mate with the plurality of divider tabs. It is envisioned that the divider is to be placed into the storage container base in a downward direction. Use of the plurality of divider tabs help guide the end user to place the divider in the correct position between the plurality of alignment guides at the bottom of the storage container base. When placed in the correct location, the plurality of divider tabs helps secure the upper portion of the divider from being accidentally dislodged from the correct position at the divider upper portion in the same manner that the plurality of alignment guides and central divider protrusion helps keep the divider from being accidentally dislodged from the correct position at the divider lower portion.

Also viewed in the bottom-up perspective view of FIGS. 5A and 5B are a plurality of outer sidewall extensions. This plurality of outer sidewall extensions 578 extend outward from the exterior surface of at least one side wall of the storage container base. As viewed in FIGS. 5A and 5B, two outer sidewall extensions, a first outer sidewall extension 580, and a second outer sidewall extension 582, are viewed on the front facing side wall and it is to be understood that two additional corresponding outer side wall extensions may also be present on the rear facing side wall. The location of the plurality of outer sidewall extensions should be placed outside of any base attachment viewed or present on any sidewall. Of course, other designs and locations of the plurality of outer sidewall extensions are possible. The plurality of outer sidewall extensions are located on the upper portion of the side wall of any number of side walls in which they are present. The plurality of outer sidewall extensions may attach generally to the overall top edge of the storage container base and be affixed to the side wall on which they are present, the first storage container base top edge surface, and the storage container base side edge. At these sidewall locations and with this attachment to overall top edge of the storage container base, the plurality of outer sidewall extensions make the deforming and pliable nature of the base attachment and the corresponding storage container base side edge area more difficult to manipulate by the end user. Thus, a stronger connection and airtight seal can be created between the storage container lid and the storage container base with the use of the plurality of outer sidewall extensions. Additionally, the plurality of outer sidewall extensions do not extend far downward along the side wall where they are present. While they extend below the second storage container base top edge surface, they may not as viewed in FIGS. 5A and 5B continue to the middle or lower portions of the side wall exterior surface. The presence of the plurality of outer sidewall extensions allows for easy stacking and removal of multiple storage container bases when not in use. Thus, when a first storage container base nests within a second storage container base, the plurality of outer sidewall extensions on the first storage container base contacts the first storage container base top edge surface of the second storage container. The plurality of outer sidewall extensions provides for a void space between the first storage container base nested within the second storage container base so that the end user can easily grasp and separate the first storage container base from the second storage container base when use of the first storage container base is desired.

The storage container base may also have an edge spacing 584. The edge spacing is a generally open cavity that circumnavigates the top outer area adjacent the upper portion of the plurality of side walls. The edge spacing bounded on one side by the storage container base side edge and the other side by the corresponding distance of the side wall adjacent the storage container base side edge. The edge spacing is open at the bottom and is bounded on the top by the first storage container base top edge surface adjacent each of the corresponding side walls and the storage container base side edge. The edge spacing provides the user a graspable opening to secure and manipulate the storage container base and more importantly the storage container base side edge near the associated positions of the plurality of base attachments. This helps the end user secure or remove the storage container lid from the storage container base by being able to deform the necessary components of the storage container base, particularly the storage container base side edge near a base attachment, to help secure or remove the storage container lid.

The storage container base may also have a plurality of surface legs. The plurality of surface legs may generally be present and extend downward from the exterior surface of the bottom wall of the storage container base. The plurality of surface legs for the storage container base of or and assembled storage container have the ability to rest without direct contact, unless desired, on either the tray or the plurality of cooling inserts of the storage container assembly set in the assembled configuration or a general surface or on top of another assembled storage container having a storage container lid in a dissembled position. As viewed in FIGS. 5A and 5B, the plurality of surface legs present on each storage container base may include at least four surface legs, a first surface leg 245, a second surface leg 250, a third surface leg 586, and a fourth surface leg 588, but other positional locations, surface leg numbers, or surface leg designs are possible and envisioned. Each surface leg of the plurality of surface legs on the storage container base may be present as a thin semicircular protrusion downward from the exterior surface of the bottom wall of the storage container base. The semicircular design of the surface leg may also travel a longer horizontal distance and have a larger length than the cross-sectional width or thickness of the surface leg that extends in the downward direction. This particular shape of the plurality of surface legs helps align the corresponding storage container base into proper contact with the plurality of cooling inserts when used in the storage container assembly set in the assembled formations. Additionally, the shape of the plurality of surface legs and can fit into corresponding grooved channels that may be present on a second storage container having a storage container lid attached when disassembled use is preferred.

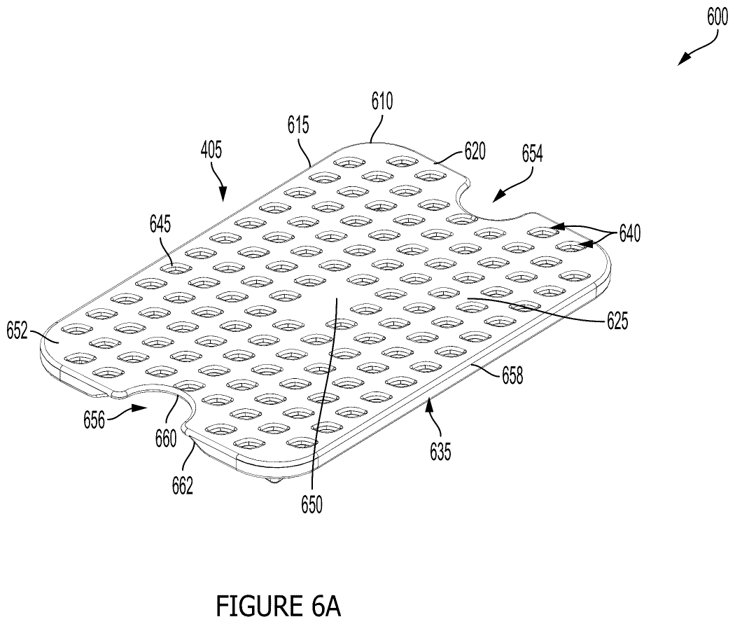

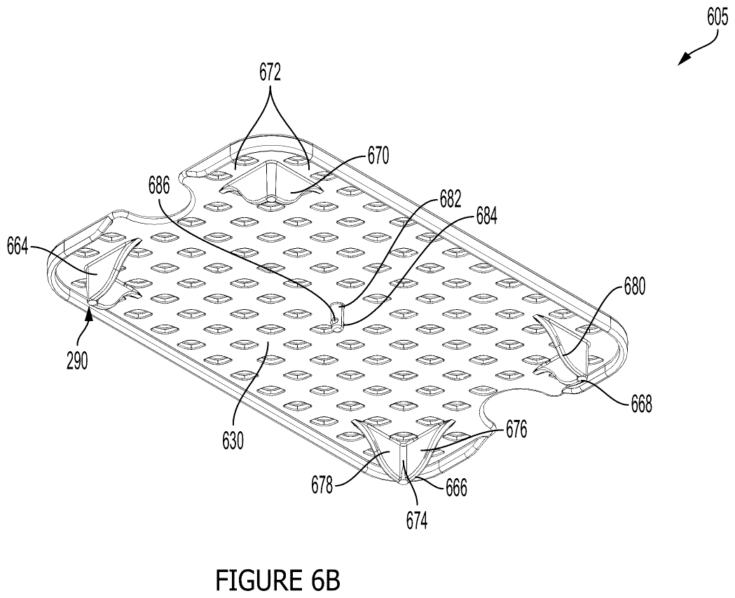

In FIGS. 6A and 6B, a drainage shelf top-down perspective view 600 (FIG. 6A) and a drainage shelf bottom-up perspective view 605 (FIG. 6B) of a drainage shelf that may be used with the storage container that may be part of the storage container assembly set is shown. The drainage shelf may be created by any type of material suitable and safe to contact food items or prepared food products. For example, the drainage shelf may be created with the use of food grade plastics, food grade polymer-based materials, or the like that are rated safe for food items or food product contact. The drainage shelf is envisioned to be continuous and may be made my mold injected material to create such a continuous design, but other manufacturing options are possible based on the configuration and materials used to create the drainage shelf. Additionally, the drainage shelf is envisioned to generally be constructed of dishwasher safe materials such that the drainage shelf can easily be washed within dishwashing machines for simple clean up and to remove any remaining food items or prepared food products after operational use. In other embodiments, the drainage shelf may be made out of food grade metals or metallic alloys or the like. For dry food use, the drainage shelf may also be created with wooden type materials, or other possible materials. Additionally, in some instances the drainage shelf may be created by a combination of materials. Further, the materials used to create the drainage shelf may have insulative properties or allow for easy transmission of thermal heating or cooling into the drainage shelf to adjust or maintain the temperature of the food items or prepared food products in contact with the drainage shelf as desired by the end user. In some instances, only the food facing surface may be made of such thermal property materials to help aid in the cooling, heating, or maintenance of temperature of any food items or prepared food products contacting the drainage shelf.

The drainage shelf is to be used within the storage container and more particularly within the storage container base. The overall length and width of the drainage shelf are determined so that when the drainage shelf is placed into the storage container base the drainage shelf should be a relatively snug and stable fit within the storage container base. Further, the length and width of the drainage shelf should be consistent with the dimensional portion of the plurality of side walls of the storage container base when placed in the correct position. The drainage shelf is to be easily placeable and removeable but should not be able to easily be positioned incorrectly within the storage container base after it is placed and especially if a food item or prepared food product is present and held upon the drainage shelf. As viewed in FIGS. 6A and 6B, the side edge connection 610 of the shelf length sides 615 with the shelf width sides 620 sides may be rounded at such side edge connection 610 corner. This is to mirror the configuration of the storage container base.

The drainage shelf may have a top shelf surface 625, a bottom shelf surface 630, and a side shelf surface 635. The top surface of the drainage shelf is generally flat and planer in overall dimension. Present on the drainage shelf top surface and traveling through the drainage shelf to and through the drainage shelf bottom surface may be a plurality of drain shelf openings 640. The plurality of drain openings may be present in different numbers and sized configurations. As viewed in FIGS. 6A and 6B, the plurality of drain openings may include 114 individual drain openings, but other numbers and configurations are envisioned. A drain opening 645 of the plurality of drain openings may be of the same or similar design. The plurality of drain openings viewed in FIGS. 6A and 6B have a generally elliptical design, but other designs such as oval, circular, square, triangular, or rectangular are possible and envisions. The shape of each drain opening creating the plurality of drain openings should be sufficient for at least the passage of water, liquid, or other undesirable solids or particles to pass through the drainage shelf. After passing through the drainage shelf placed inside the storage container base, the water, liquids, or other undesirable solids or particles will rest and collect upon the interior surface of the bottom wall of the storage container base. Placement of the plurality of drain openings is envisioned to cover most of the surface area of the drainage shelf but can be adjusted for particular use of the drainage shelf with specific food items or prepared food products.

Drain openings on the drainage shelf are generally absent from the drainage shelf in FIGS. 6A and 6B at the central shelf region 650, corner shelf regions 652, and a middle shelf region of the shorter width lengths of the drainage shelf that contact the shorter width side walls of the plurality of side walls of the storage container base. Of course, other configurations of the drainage shelf may have drain openings at these locations. The general corners of the drainage shelf are rounded. To maintain structural integrity of the drainage shelf, these locations are absent drain openings as viewed in the example of FIGS. 6A and 6B. The middle regions of the shorter width lengths of the drainage shelf are absent drain openings for a different purpose as viewed in FIGS. 6A and 6B. In these middle regions of the shorter width lengths of the drainage shelf, at least one drainage shelf grasping point may be present. The example of FIGS. 6A and 6B show a first shelf grasping location 654 and a second shelf grasping location 656 directionally opposing the position of the first drainage shelf grasping point. While the drainage shelf is generally meant to contour and gently contact at least part of the storage container base, the middle portion of the shorter width lengths of the drainage shelf are not desired for such contact. On the front end, or one end, and along the shorter width length at the middle portion of the drainage shelf, the first drainage shelf grasping point is formed by removing a semicircular portion of the drainage shelf that would have been present if the drainage shelf was to run continuous along the shorter width length. On the back end, or second end opposite the first end, and along the shorter width length at the middle portion of the drainage shelf, the second drainage shelf grasping point is formed by removing a semicircular portion of the drainage shelf that would have been present if the drainage shelf was to run continuous along the shorter width length. These semicircular cutouts of the drainage shelf form the first and second drainage shelf grasping points. During operational use and when the user wishes to use the drainage shelf to hold food items or prepared food products, the end user may grasp the entire drainage shelf by the first drainage shelf grasping point, second drainage shelf grasping point, or preferably by both the first and second drainage shelf grasping points with the drainage shelf top surface facing upward. The user can then, while grasping the first drainage shelf grasping point, second drainage shelf grasping point, or preferably by both the first and second drainage shelf grasping points, place the drainage shelf within the storage container base within the proper placement on the bottom wall of the storage container base to allow food items or prepared food products added to the storage container base the ability to rest upon the top surface of the drainage shelf.

Additionally, the drainage shelf may have a shelf side wall 658. The drainage shelf side wall can extend downward from the drainage shelf top surface. It can then, as viewed in FIGS. 6A and 6B, further extend downward below the location of the drainage shelf bottom surface. The length downward of the drainage shelf side wall is generally continuous and circumscribes the perimeter edge of the top surface of the drainage shelf in the downward direction. However, as viewed in FIGS. 6A and 6B, the drainage shelf side wall may be shorter in length than its generally consistent downward length at a few points on the drainage shelf. In particular, the drainage shelf side wall may be shorter in length as it approaches, and as the side wall continues along the location of the first and second drainage shelf grasping points. A cut-out location 660 of the drainage shelf forming the first and second drainage shelf grasping points, the length downward of the first and drainage shelf may a taper 662, wherein the taper 662 flows upward to decrease the overall length of the drainage shelf side wall at these locations. Ultimately, the taper of the drainage shelf side wall will end when the downward length of the drainage shelf side wall is consistent with the overall thickness of the drainage shelf from the drainage shelf top surface to the drainage shelf bottom surface. The taper design along with a smaller drainage shelf side wall overall at each the first and second drainage shelf grasping points allows the user to easily move and place their finger under the drainage shelf to grasp and remove the drainage shelf when its use is no longer desired.

Opposite of the drainage shelf top surface, the drainage shelf may have a drainage shelf bottom surface. The drainage shelf bottom surface is where the plurality of drain opening terminates to allow the undesired water, liquid, or other undesirable solids or particles to pass through the drainage shelf. Furthermore, the drainage shelf bottom surface may have a few additional components not present on the drainage shelf top surface. Unlike the drainage shelf top surface, the drainage shelf bottom surface is not generally planer and flat in nature. Extending away and downward from the drainage shelf bottom surface may be at least one drainage shelf leg. As viewed in FIGS. 6A and 6B, the drainage shelf bottom surface may contain a plurality of drainage shelf side walls. The example of FIGS. 6A and 6B shows four drainage shelf legs, a second side wall 664, a third side wall 666, a fourth side wall 668, and a fourth side wall connection 670, but it should be understood that a different number of drainage shelf legs or drainage shelf leg designs are envisioned. The plurality of drainage shelf legs may be at an offset 672 from the exact corners of the drainage shelf bottom surface a set distance of length and width. This is needed as the connection between the bottom wall and the plurality of side walls of the storage container base has an upward curve. The offset of the plurality of drainage shelf legs allows for the drainage shelf to rest flat upon and bottom wall of the storage container base to support the drainage shelf.

The plurality of drainage shelf legs of FIGS. 6A and 6B may be generally described as triangular in design. Each drainage shelf leg may have a leg post 674, a first leg panel 676, and a second leg panel 678. Of course, other designs and configurations are possible. The leg post may be cylindrical in nature and extend downward and away from the drainage shelf bottom surface to create the maximum length of the drainage shelf leg. A combination of the leg post length with the overall thickness of the drainage shelf between the top and bottom surface creates the height the drainage shelf will rest above the bottom wall of the storage container base when in proper placement. The first leg panel and the second leg panel are attached and affixed to the leg post. The first leg panel extends outward in a first direction from the leg post and the second leg panel extends outward from the leg post in a second direction. The first direction and the second direction may be approximately 90 degrees from one another where the first and second leg panels are placed. The first leg panel may extend outward a specific length. The first leg panel is attached or affixed to the bottom surface of the drainage shelf the entire specific length of the outward first direction extension. The first leg panel may have a first leg panel thickness and first leg panel surface area including a first side of the first leg panel and a second side of the first leg panel. The first leg panel is then attached or affixed to both the leg post and the drainage shelf bottom surface throughout the length of the first direction. As the first leg panel surface area moves from the leg post to a termination point of the first direction, the vertical measurement of the first leg panel to help define the first leg panel surface area decreases until there is no more vertical rise at the termination point of the first direction. As viewed in FIGS. 6A and 6B, the first leg panel shape may have an S type design 680 as it moves from the leg post to the termination point in the first direction.

The second leg panel may extend outward a second specific length. The second leg panel is attached for affixed to the bottom surface of the drainage shelf the entire second specific length of the outward second direction extension. The second leg panel may have a second leg panel thickness and second leg panel surface area including a first side of the second leg panel and a second side of the second leg panel. The second leg panel is then attached or affixed to both the leg post and the drainage shelf bottom surface throughout the length of the second direction. As the second leg panel surface area moves from the leg post to a termination point of the second direction, the vertical measurement of the second leg panel to help define the second leg panel surface area decreases until there is no more vertical rise at the termination point of the second direction. As viewed in FIGS. 6A and 6B, the second leg panel shape may have an S type design as it moves from the leg post to the termination point in the second direction.

Centrally located on the drainage shelf bottom surface a shelf connector 682 is present. The shelf connector may be in the middle of both the overall length and width of the drainage shelf, but of course other locations are possible and envisioned. The drainage shelf connector extends vertically downward from the drainage shelf bottom surface. However, the drainage shelf connector is not as long as the leg post association with each drainage shelf leg of the plurality of drainage shelf legs. Thus, the drainage shelf connector is not meant to contact the interior surface of the bottom wall of the storage container base. The drainage shelf connector may be generally conical, but not terminating in a point. The end of the drainage shelf connector attached and affixed to the drainage shelf bottom surface may have a larger diameter than the termination point of the extended end of the drainage shelf connector. Of course, other designs are possible.

Near the extended end of the drainage shelf connector at least one connector tab is present. As viewed in FIGS. 6A and 6B, a plurality of connector tabs 684 and 686, a first connector tab 684 and a second connector tab 686, may be used. Other possible numbers or locational positions of the connector tab are envisioned. The first connector tab may be near the extended end of the drainage shelf connector but is not located exactly at the extended end point. The second connector tab may be located 180 degrees from or opposite the location of the first connector tab on the drainage shelf connector. Each the first connector tab and the second connector tab protrude slightly outward and away from the drainage shelf connector. Directly adjacent the termination point of the drainage shelf connector the side wall of the drainage shelf connector may bevel inward toward the smaller diameter of the drainage shelf connector located at the termination point of the extended end.

The drainage shelf connector is created for use if the drainage shelf is not desired to be used by the end user and thereby placed within the storage container base. While the drainage shelf can simply be stored by itself in any suitable storage location, the drainage shelf connector allows for a more optimal storage position. When the drainage shelf is not in use, the drainage shelf by way of the drainage shelf connector can removably be attached to a location present on the bottom surface of the storage container lid. The opening on the storage container lid is created to accept the drainage shelf connector by way of a snap fit connection. To store the drainage shelf attached to the storage container lid, the end user will line up the drainage shelf connecter with the appropriate opening on the bottom surface of the storage container lid and push the drainage shelf connect into the appropriate opening. Pushing the drainage shelf connection into the opening on the storage container lid locks the drainage shelf to the storage container lid. The first and second connector tabs viewed in FIGS. 6A and 6B and present on the drainage shelf connector are forced through a friction barrier present within the opening on the storage container lid. Once the first and second connector tabs pass the friction barrier, the drainage shelf is secured by contact between the first and second connector tabs of the drainage shelf connector and the barrier present on the opening of the storage container lid. Then, when use is desired by the end user, the user can simply grasp the storage container lid in one hand and the drainage shelf in the other hand and pull to remove the drainage shelf connector from the opening on the storage container lid. The snap fit connection between the drainage shelf connector and the opening on the storage container lid is strong enough to continuously hold the drainage shelf, but not so strong as to prevent easy removal by the user when use of the drainage shelf is desired.

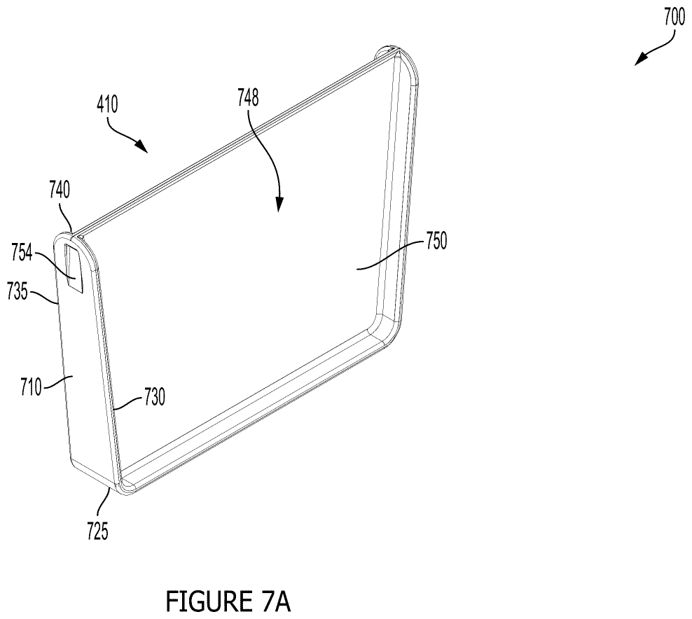

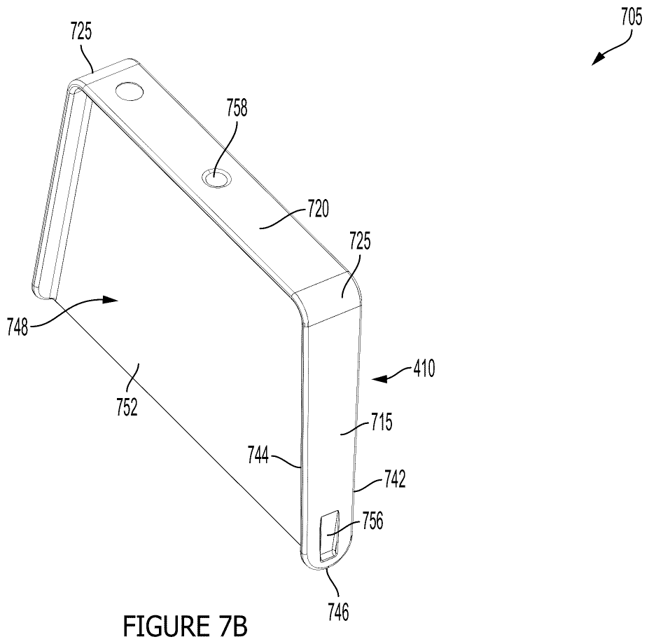

Looking at FIGS. 7A and 7B, a divider top-down perspective view 700 (FIG. 7A) and a divider bottom-up perspective view 705 (FIG. 7B) of a divider that may be used with the storage container that may be part of the storage container assembly set is shown. The divider may be created by any type of material suitable and safe to contact food items or prepared food products. For example, the divider may be created with the use of food grade plastics, food grade polymer-based materials, or the like that are rated safe for food items or food product contact. The divider is envisioned to be continuous and may be made by mold injected material to create such a continuous design, but other manufacturing options are possible based on the configuration and materials used to create the divider. Additionally, the divider is envisioned to generally be constructed of dishwasher safe materials such that the drainage shelf can easily be washed within dishwashing machines for simple clean up and to remove any remaining food items or prepared food products after operational use. In other embodiments, the divider may be made out of food grade metals or metallic alloys or the like. For dry food use, the divider may also be created with wooden type materials, or other possible materials. Additionally, in some instances the drainage shelf may be created by a combination of materials.

The divider may have multiple walls and contact surfaces. However, the number of walls or contact surfaces may be driven by the type of divider to be used in the storage container base and the number of interior subareas such divider may portion from the general interior area of the storage container base. The divider viewed in FIGS. 7A and 7B may have a first side wall face 710, a second side wall face 715, and a bottom wall face 720. The general height from which each the first side wall face, the second side wall face, and the bottom wall face travels away from the interior surface of their respective side walls or the bottom wall of the storage container base and into the interior volume area of the storage container base is relatively the same. The general width from which each the first side wall face, the second side wall face, and the bottom wall face travel horizontally when placed against their respective side walls or the bottom wall is also generally the same. While the width of the bottom wall face is consistent over the entire length the bottom wall face rests against the bottom wall of the storage container base, the width of each the first side wall face and the second side wall face may taper to a slightly smaller width as the first side wall face and the second side wall face travel upwards towards the overall top edge of the storage container base on their respective side walls. Further, the length of the first side wall face, the second side wall face, and the bottom wall face travel (horizontally for the bottom wall face and vertically for the first and second side wall faces) may be different than the overall shape of the storage container base. The length of the bottom wall face will generally match the width and contour of the bottom wall of the storage container base. The first side wall face and the second side wall face are not envisioned with the embodiment viewed in FIGS. 7A and 7B to match the entire upward height of the side wall they may contact as those side walls move upward from the bottom wall to the overall top edge of the storage container base. Overall, the length of the first side wall face and the second side wall face may travel halfway up or up to ⅞ the way up the height of the side wall they may contact as those side walls move upward from the bottom wall to the overall top edge of the storage container base. This may be done to accommodate the drainage shelf if it is stored beneath and attached to the storage container lid if the storage container lid was to be attached in a sealing fashion with the storage container base. Generally, the overall length of the first side wall face and the second side wall face is the same. In some embodiments the overall length of the first side wall face and the second side wall face may also be the same as the length of the bottom wall face. Of course, different lengths, widths, and heights of the first side wall face, the second side wall face, and bottom wall face are envisioned and can be employed with a functional divider.

The overall width of the bottom wall face of the divider is preferable to be a width where the divider can stand alone without support. A divider connection 725 of the bottom wall face to each the first side wall face and the second side wall face is envisioned to be contoured to the connections of the bottom wall with the respective side walls that will contact the divider in a use orientation within the storage container base. As viewed in FIGS. 7A and 7B, the connection of the bottom wall face to each the first side wall face and the second side wall face is rounded to meet the contour of the storage container base disclosed above in FIGS. 5A and 5B.

Each the first side wall face and the second side wall face of the divider do not attach or connect to a top wall face as none is present. A first edge 730 of the first side wall face travels upwards from the connection to the bottom wall face along the length of the first side wall face until near the apex of the first side wall face's overall length. At this point, the first edge of the first side wall face curves inwards toward a second edge 735 of the first side wall face traveling upwards from the connection to the bottom wall face along the length of the first side wall face until near the apex of the first side wall face's overall length. The second edge of the first side wall face travels upwards from the connection to the bottom wall face along the length of the first side wall face until near the apex of the first side wall face's overall length. Like the first edge, the second edge of the first side wall face curves inwards toward the first edge of the first side wall face traveling upwards from the connection to the bottom wall face along the length of the first side wall face until near the apex of the first side wall face's overall length. The curved portion of the first edge and the curved portion of the second edge of the first wall face meet at a first face central point 740. The central point is usually the middle of the general width of the first wall face and also usually the middle of the width of the second wall face and the bottom wall face.

Similarly, a first edge 742 of the second side wall face travels upwards from the connection to the bottom wall face along the length of the second side wall face until near the apex of the second side wall face's overall length. At this point, the first edge of the second side wall face curves inwards toward a second edge 744 of the second side wall face traveling upwards from the connection to the bottom wall face along the length of the second side wall face until near the apex of the second side wall face's overall length. The second edge of the second side wall face travels upwards from the connection to the bottom wall face along the length of the second side wall face until near the apex of the second side wall face's overall length. Like the first edge, the second edge of the second side wall face curves inwards toward the first edge of the second side wall face traveling upwards from the connection to the bottom wall face along the length of the second side wall face until near the apex of the second side wall face's overall length. The curved portion of the first edge and the curved portion of the second edge of the second wall face meet at a second face central point 746. The central point is usually the middle of the general width of the second wall face and also usually the middle of the width of the first wall face and the bottom wall face.

Instead of a top wall face, the divider may have an interior wall 748. The interior wall should be thick enough so that pressure from storage food items within the storage container base on either side of the interior wall are not powerful enough to dislodge the divider or deform the generally straight configuration of the interior wall. The overall shape and design of the interior wall is based on the overall shape, design, and contour of the storage container base. The interior wall will attach and be affixed to each the first side wall face, the second side wall face, and the bottom wall face. Generally, it is envisioned that the divider with the multiple faces is made and consists of a single material during manufacture securing all connections. Also, the interior wall is generally positioned at the central point that is usually common with the divider even if the widths are different for the first side wall face, second side wall face, and bottom wall face. The interior wall may have a first interior wall side 750 creating a boundary of a first interior portion of the storage container base that is able to contact and hold food items and prepared food products against the first interior wall side. The interior wall may also have a second interior wall side 752 creating a boundary of a second interior portion of the storage container base that is able to contact and hold food items and prepared food products against the second interior wall side.

Each the first side wall face and the second side wall face may have a first divider tab recess 754 and a second divider tab recess 756. Thus, a plurality of divider tab recesses 754 and 756 are present on the divider viewed in FIGS. 7A and 7B. Each divider tab recess may be located on the upper portion of the respective first or second side wall face. The divider tab recess may be formed into the overall thickness of each the first and second side wall face and centered over the width of each the first and second side wall face. The plurality of divider tab recesses are created to match the plurality of divider tabs present on the storage container base. Thus, when the divider is placed into the storage container base for operational use of the divider, the plurality of divider tabs will mate with the plurality of divider tab recesses located on the divider to secure the upper portion of the divider into the storage container base in the correct orientation.

Additionally, the divider has features to secure the lower portion of the divider to the storage container base. Generally, it should be understood and appreciated that the overall width of the bottom wall face is the same or slightly smaller than the width that may be present between at least two alignment guides located at the connection of the bottom wall and a side wall of the storage container base. Thus, a plurality of alignment guides present within the storage container base can hold and secure the lower portion of the divider in the correct orientation and position within the storage container base. Further, the bottom wall face in contact with the bottom wall of the storage container base may have a central divider recess 758. The central divider recess may be located in the middle of both the width and length of the bottom wall face. When the divider is placed into the storage container base for operational use, the central divider recess will cover and contact the central divider protrusion that may be present on the bottom wall of the storage container surface. This contact helps to additionally support and position the divider in the correct operational orientation and secure the lower portion of the divider to the storage container base.

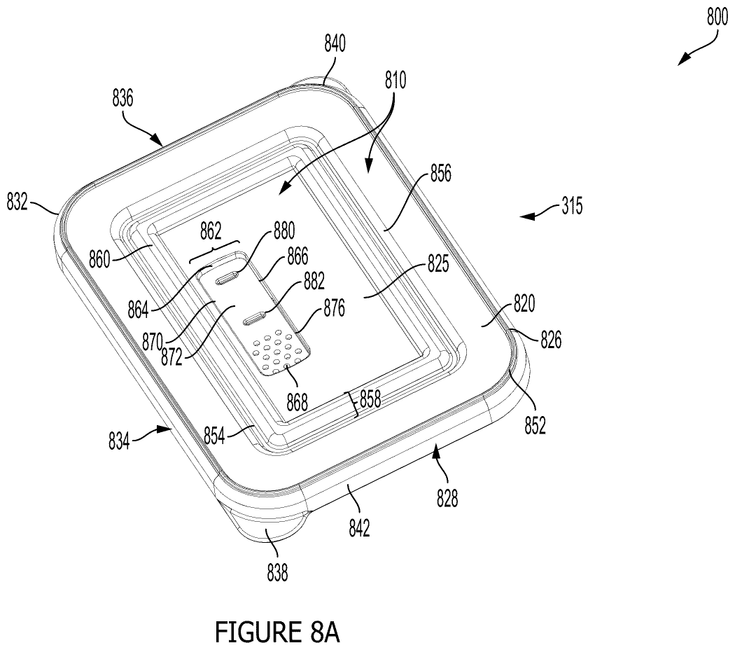

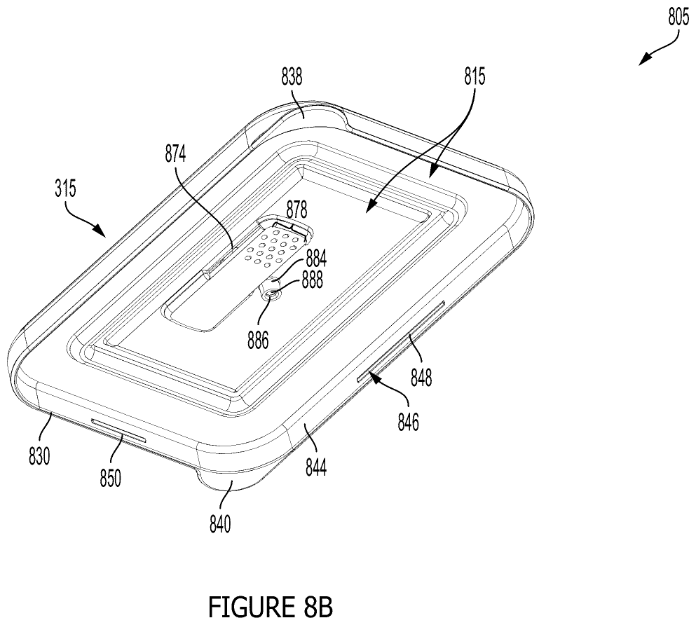

In FIGS. 8A and 8B, a lid top-down perspective view 800 (FIG. 8A) and a lid bottom-up perspective view 805 (FIG. 8B) of a storage container lid that may be used with the storage container that may be part of the storage container assembly set is shown. The storage container lid may be created by any type of material suitable and safe to store food items or prepared food products. For example, the storage container lid may be created with the use of food grade plastics, food grade polymer-based materials, or the like that are rated safe for food item or food product contact. The storage container lid is envisioned to be generally continuous and may be made by mold injected material to create such a continuous design, but other manufacturing options are possible based on the configuration and materials used to create the storage container base. Additionally, the storage container lid is envisioned to generally be constructed of dishwasher safe materials such that the storage container lid can easily be washed within dishwashing machines for simple clean up and to remove any remaining food items or prepared food products after operational use. In other embodiments, the storage container lid may be made out of food grade metals or metallic alloys or the like. For dry food use, the storage container lid may also be created with wooden type materials, or other possible materials. Additionally, in some instances the storage container lid may be created by a combination of materials.

The storage container lid is designed to be slightly larger than the overall top edge of the storage container base. The storage container lid is also designed to have the same dimensional characterization of the plurality of side walls and overall top edge of the storage container base so that it can be attached and be secured to the storage container base. The storage container lid may have a top lid surface 810 and a bottom lid surface 815. Generally, the storage container lid is configured to fit onto and create a seal with the storage container base to securely contain a food item or prepared food products. When sealed to the storage container base, the storage container lid and the storage container base can create an airtight or almost vacuum like seal where no outside air can enter into the interior volume area of the storage container base. The top surface of the storage container lid may further be separated into a first top lid surface 820 and a second top lid surface 825. The first storage container lid top surface is generally configured and viewed in FIGS. 8A and 8B to be raised above the second storage container lid top surface, but of course other configurations and designs of the top surface of the storage container lid are possible and envisioned.

The first storage container lid top surface may start at an outer top edge 826 of the storage container lid and move inward. Moving outward from the top edge where the first storage container lid top surface begins, the storage container lid may curve in a downward direction to create a lid side wall 828. The storage container lid side wall is generally perpendicular to the first storage container lid top surface or the overall top surface of the storage lid container The length the storage container lid side wall travels in the downward direction and is generally the same length, if not a bit shorter, than the overall length of the storage container base side edge surface so that the storage container lid side wall can cover and mate with the storage container base side edge surface in a sealing fashion to prevent air from leaving or entering a sealed storage container design. At the bottom of the storage container lid side wall a lid side wall edge 830 is present. The storage container lid side wall edge can rest upon the short second storage container base top edge surface when the storage container lid and the storage container base are in a sealing arrangement.

A side lid connection 832 between the lid length sides 834 and the lid width sides 836 of the storage container lid, located at the storage container lid side wall edge a lid extension 838 or 840, may be present. As viewed in FIGS. 8A and 8B, a first lid extension 838 and a second lid extension 840 form a plurality of lid extensions 838 or 840. Each storage container lid extension may extend outward a predetermined distance horizontally from the storage container lid side wall edge. The connection of the length sides of the storage container lid and the width sides of the storage container lid may be rounded. This rounding may be present in both the storage container lid side wall and the storage container lid side wall edge as it surrounds and circumnavigates the perimeter of the storage container lid. As such, each storage container lid extension may have a similar design. As viewed in the example of FIGS. 8A and 8B, each storage container lid extension expands outward horizontally from the storage container lid side wall edge but in alignment with the storage container lid side wall edge that travels along the side of the storage lid container with the greatest length. As viewed in FIGS. 8A and 8B, a first storage container lid extension may extend horizontally outward from the front side of the storage container lid side wall edge in alignment with the storage container lid side wall edge creating the left side. The second storage container lid extension may extend horizontally outward from the rear side of the storage container lid side wall edge in alignment with the storage container lid side wall edge creating the right side. As both the first and second storage container lid extensions extend beyond the respective front side and rear side storage container lid side wall edges, the first and second storage container lid extensions loop back toward their respective front side and rear side storage container lid side wall edges to reconnect to each the front side and rear storage side container lid side wall edges. The first and second storage container lid extensions allow for a user to easily grasp the storage container lid. By that grasping the storage container lid from storage to then be placed upon the storage container base to seal an assembled storage container, or to grasp the storage container lid when the storage container lid is already sealed with the storage container base to remove the storage container lid from the storage container base.

The storage container lid side wall that surrounds the storage container lid may have an exterior lid surface 842 and an interior lid surface 844. On the interior surface of each area of the storage container lid side wall that corresponds to a side wall of the plurality of side walls of the storage container base, a plurality of lid attachments 846 may be present. For example, and viewed in FIGS. 5 and 8, there are four side walls for the storage container base so four lid attachments may be present to create a plurality of lid attachments. Each lid attachment of the plurality of lid attachments may be generally centered along the length of the corresponding side wall of the storage container base where the storage container lid side wall may attach. Further, each lid attachment of the plurality of lid attachments may be generally centered along the length on the interior surface of the storage container lid side wall that corresponds to a particular side wall of the storage container base. Each lid attachment of the plurality of lid attachments may also be generally centered along the width of the storage container lid side wall that corresponds to a particular side wall of the storage container base. Each lid attachment of the plurality of lid attachments may be a long linear protrusion that extends outward and away from the interior surface of the storage container lid side wall representative of each side wall of the storage container base. Further, the linear length of each lid attachment of the plurality of lid attachments may be adjusted based on the length of the corresponding side wall where the lid attachment may be present. For the side walls that are longer in length, the corresponding lid attachment, a first lid attachment 848, may be longer than the length of a second lid attachment 850 corresponding to a side wall of shorter length. Thus, the length of each lid attachment is determined by the length of each side wall corresponding to its position. For example, and viewed in FIGS. 5 and 8, the front and back side walls have shorter lid attachments of a similar length while the left and right-side walls have longer lid attachments of a similar length.

The overall thickness of the storage container lid side wall should allow it to be pliable and deformable when manipulated by the end user. While the storage container lid side wall is pliable and deformable, once it is deformed or moved from its resting configuration, it will quickly return to the resting configuration. Thus, the storage container lid side wall can easily fit and accommodate onto the overall top edge of the storage container base and be removably attached to the overall top edge of the storage container base. In doing so, the user may manipulate or deform particular locations of the storage container lid side wall near one or more of the lid attachments to fit the storage container lid onto the overall top edge of the storage container base and below the plurality of base attachments that are present on the storage container base. The plurality of lid attachments that extend from the storage container lid side wall onto and over the overall top edge of the storage container base may be in position a greater distance away from the bottom surface of the storage container lid than the plurality of base attachments that are in position on the overall top edge of the storage container base in their respective locations. Manipulation by the end user of either the storage container base side edge surface near one or more of the base attachments or the storage container lid side wall near one or more of the lid attachments then allows for the plurality of lid attachments to fit on and over the plurality of base attachments on the storage container base side edge surface. In most envisioned use cases, when the storage container lid is in the sealed position with the storage container base, the plurality of lid attachments are located below the plurality of base attachments. Thus, upward force on the storage container lid alone may not be enough to remove the storage container lid from the storage container base due to the contact and friction of the snap fit connection between the plurality of lid attachments and plurality of base attachments. Further, to efficiently and effectively remove the storage container lid from the sealing position on the storage container base the user may manipulate the pliable and deformable nature of either the storage container base side edge surfaces near one or more of the base attachments or the storage container lid side wall near one or more of the lid attachments which allows the user to create enough gap space so that the corresponding plurality of lid attachments may pass over the plurality of base attachments on the storage container base side edge surface so that the storage lid container can be easily removed.

The first storage container lid top surface may start at the outer top edge of the storage container lid and move inward. The first storage container lid top surface is generally flat and planer while elements of the storage container lid do not adjust or change its overall configuration. Moving inward towards the center of the storage container lid, the first storage container lid top surface contacts a raised surface edge ridge 852. The raised top surface edge ridge is located near the overall edges of the storage container lid and rises upward slightly above the first storage container lid top surface. The raised top surface edge ridge follows and circumnavigates the general overall edges on each side of the storage container lid. As viewed in FIGS. 8A and 8B, the raised top surface edge ridge is continuous and further encloses the middle area of the top surface of the storage container lid. The raised surface edge ridge is able to contain spills or leakage from food product preparation and needs the storage container lid as well as the release of any leakage that may drip down and collect on the storage container lid from a second storage container placed upon and resting on the storage container lid.

After the raised surface edge ridge, the top surface of the storage container lid drops back down and returns to the first storage container lid top surface position. The first storage container lid top surface continues inward until a top surface channel 854 is present. The first storage container lid top surface curves downward to create the top surface channel. The top surface channel is rectangular as viewed in FIGS. 8A and 8B, but other configurations are envisioned. Further, the top surface channel is bounded on one side by an upward slope 856 to the first storage container lid top surface position and the other side by a channel ridge 858. The bottom of the top surface channel drops to a depth consistent with the depth of the second storage container lid top surface position on the storage container lid. In operational use, the top surface channel is present on the storage container lid to help secure a second storage container placed upon and resting on the storage container lid. As stated above, a plurality of surface legs may generally be present and extend downward from each storage container base. The design, location, and configuration of the plurality of surface legs present on the storage container base allows the plurality of surface legs to nest and fit within the top surface channel and be secured within the top surface channel by the boundaries of the upward slope to the first storage container lid top surface position and the channel ridge. Fit within the top surface channel, the second storage container secured on the storage container lid will not move during normal controlled transit by the user without substantial outside force.

Continuing inward towards the center of the storage container lid and after the top surface channel, the channel ridge is present. The channel ridge slopes upwards to a top channel ridge surface 860 and then back downward to a lower surface position. The upward slope of the channel ridge towards the top channel ridge surface bounds one side of the top surface channel. The channel ridge is rectangular as viewed in FIGS. 8A and 8B, but other configurations are envisioned. As it is inside the top surface channel, the rectangular configuration of the channel ridge is smaller than the top surface channel. The top channel ridge surface is raised to the same position of the first storage container lid top surface position on the outer edge area of the storage container lid. The downward slope from the top channel ridge surface ends at the second storage container lid top surface position of the storage container lid. Generally, the purpose of the channel ridge is to bound the top surface channel and secure a storage container stacked upon the storage container lid in a correct and proper orientation.

After the channel ridge, the storage container lid top surface remains in the second storage container lid top surface position. The second storage container lid top surface position is understood to be below the first storage container lid top surface position on the outer general edges of the storage container lid. Within the area of the storage container lid in the second storage container lid top surface position, a vent slider depression 862 may be present. The vent slider depression further drops the top surface of the storage container lid to a deeper depth than the second storage container lid top surface position. The vent slider depression may be offset from the centerline of the smaller length sides of the storage container lid but centered as to the centerline of the longer length sides of the storage container lid. Of course, different positional orientations are possible for the vent slider depression, but it is recommended to be present within the second storage container lid top surface position. The vent slider depression may have a first vent side wall 864, a second vent side wall 866, a third vent side wall 868, and a fourth vent side wall 870 dropping the vent slider depression to a vent slider surface 872. The vent slider depression may also have a right-side wall 862a and a left side wall 862b dropping the vent slider depression to the vent slider surface. The top side wall and the bottom side wall may be in continuous connection with each the vent slider surface and the second storage container lid top surface position. The right-side wall and the left side wall may have a closed position where they are in continuous connection with each the vent slider surface and the second storage container lid top surface position. However, each the right-side wall and the left side wall of the vent slider depression may contain a first vent slider opening 874 and a second vent slider opening 876 where the vent slider may be attached within the vent slider depression. The left side wall of the vent slider depression has a first vent slider opening and the right-side wall of the vent slider depression has a second vent slider opening. The first and second vent slider openings may mirror each other with their locations on the left and right-side walls of the vent slider depression.

The vent slider depression terminates at the vent slider surface. The vent slider may be attached within the vent slider depression by way of the first and second vent slider openings. The vent slider attached in this way allows the vent slider to move between a first position and a second position. The first position usually being a forward position and the second position usually being a backward position. The vent slider surface may have a first end and a second end. The second end of the vent slider surface may contain a plurality of air openings 878. The plurality of air opening may be present and located through the vent slider surface. The plurality of air openings may allow air to enter or exit the interior of the storage container base when the storage container lid is attached to the storage container base. The plurality of air openings may take on multiple different configurations. As viewed in FIGS. 8A and 8B, the plurality of air openings alternate as five rows. The first, third, and fifth row having three individual air openings. The second and fourth row having four individual air openings. The plurality of air openings present within one row may be offset from the air openings present in any row immediately above or below the selected row of air openings.

At the first end of the vent slider surface, a first locking position 880 and a second locking position 882 may be present. The at least one locking position may be a depression into but not through the vent slider surface. As viewed in FIGS. 8A and 8B, two locking positions are present to create a plurality of locking positions. It should be understood that more locking positions may be present as desired for the storage container lid. When the vent slider is positioned and attached within the vent slider depression, the vent slider can be moved between the first locking position and the second locking position in either the first or second direction of movement. Moving the attached vent slider from the first locking position to the second locking position, or somewhere there between, controls the amount of air, gas, or particles that may enter or leave the interior of the storage container base.

On the bottom surface of the storage container lid, a drainage shelf opening 884 is present. The drainage shelf opening is used to secure the drainage shelf to the storage container lid when the drainage shelf is not in operational use. The drainage shelf opening extends downward from the bottom surface of the storage container lid and has a generally cylindrical design as viewed in FIGS. 8A and 8B. However, it should be understood that other possible designs of the drainage shelf opening are possible and envisioned. While the drainage shelf opening is cylindrical in nature, it is not solid and has a hollow interior. The terminal end of the drainage shelf opening may have an inward catch 886 that is circular and angled slightly toward the bottom surface of the storage container lid. After the inward catch, a circular cavity 888 is present that is larger in diameter than the first inward catch and may continue to the end of the drainage shelf opening at the bottom surface of the storage container lid. As discussed above in relation to FIGS. 6A and 6B, a drainage shelf connector may be present on the drainage shelf. The drainage shelf connector may have a plurality of connector tabs near the terminal end of the drainage shelf connector. The diameter of the drainage shelf connector at the point with the connector tabs positional location 180 degrees from and opposite one another may be a larger diameter than the inward catch of the drainage shelf opening located on the bottom surface of the storage container lid. While smaller than the diameter of the inward catch of the drainage shelf opening, the diameter of the drainage shelf connector at the point with the connector tabs positional location 180 degrees from and opposite one another will fit snug but loosely within the circular cavity of the drainage shelf opening. If use of the drainage shelf is not needed, the user may push drainage shelf connector at the point with the connector tabs positional location 180 degrees from and opposite one another through the inward catch of the drainage shelf opening to create a snap fit connection. When placed in this manner, the drainage shelf connector at the point with the connector tabs positional location 180 degrees from and opposite one another will be contained within the circular cavity of the drainage shelf opening and the presence of the connector tabs positional location 180 degrees from and opposite one another on the drainage shelf connector will frictionally prevent the drainage shelf from dislodging within the drainage shelf opening as the diameter of the drainage shelf connector at the point with the connector tabs positional location 180 degrees from and opposite one another is larger than the inward catch of the drainage shelf opening. To remove the drainage shelf for operational use when desired by the end user, the user can grasp both the storage container lid and the drainage self and pull each component away from one another. This will force the drainage shelf connector at the point with the connector tabs positional location 180 degrees from and opposite one another through the smaller inward catch diameter opening and remove the connection of the drainage shelf from the storage container lid.

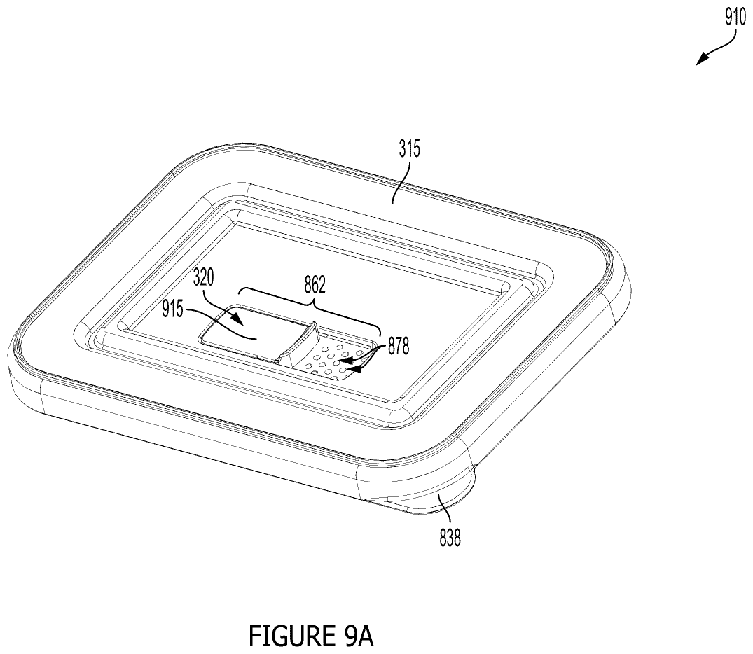

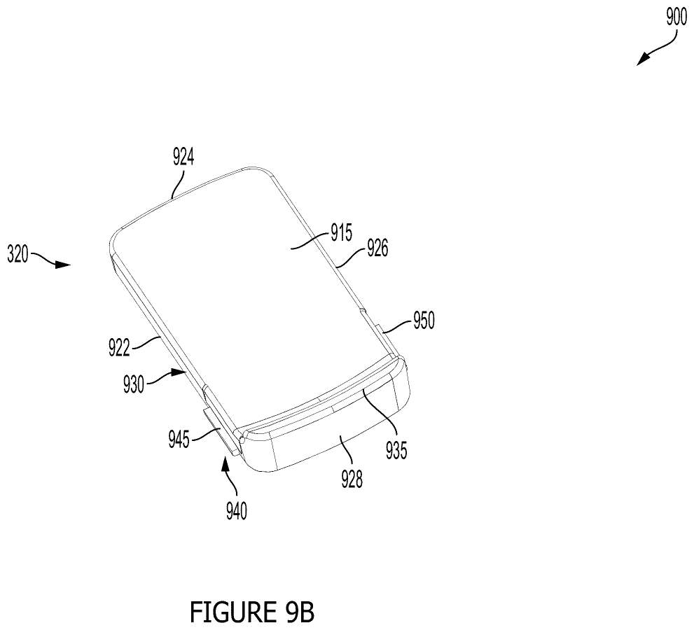

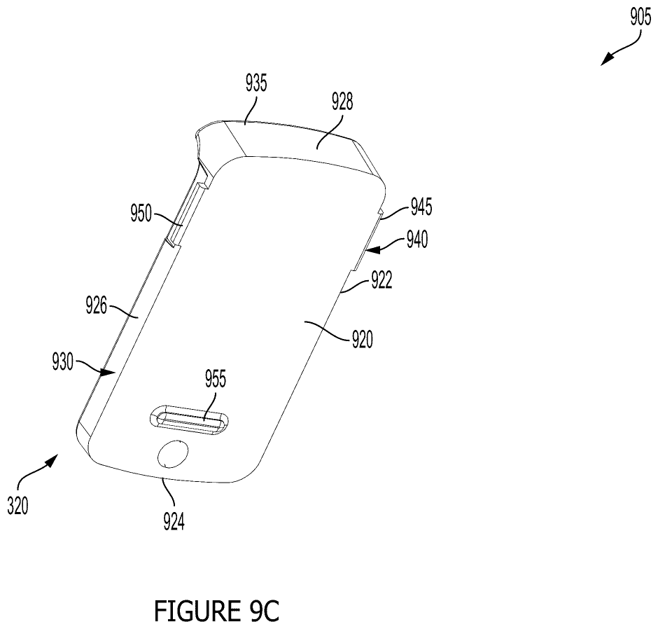

Turning now to FIGS. 9A, 9B, and 9C, a vent slider top-down perspective view 900 (FIG. 9A), a vent slider bottom-up perspective view 905 (FIG. 9B), and an attached view 910 (FIG. 9C) of a vent slider of the storage container lid that may be used with the storage container that may be part of the storage container assembly set is shown. The vent slider may be created by any type of material suitable and safe for contact with food items or prepared food products. For example, the vent slider may be created with the use of food grade plastics, food grade polymer-based materials, or the like that are rated safe for food item or food product contact. The vent slider is envisioned to be continuous and may be made my mold injected material to create such a continuous design, but other manufacturing options are possible based on the configuration and materials used to create the vent slider. Additionally, the vent slider is envisioned to generally be constructed of dishwasher safe materials such that the vent slider can easily be washed within dishwashing machines for simple clean up and to remove any remaining food items or prepared food products after operational use. In other embodiments, the vent slider may be made out of food grade metals or metallic alloys or the like. For dry food use, the vent slider may also be created with wooden type materials, or other possible materials. Additionally, in some instances the vent slider may be created by a combination of materials.

The vent slider is to be positionally placed within the vent slider depression located on the top surface of the storage container lid as viewed in FIGS. 9A-9C. After attachment within the vent slider depression, the vent slider is generally not to be removed or removable from this configuration. The vent slider itself of FIGS. 9A-9C is to be generally rectangular in shape and configured to fit within the vent slider depression on the storage container lid. Of course, it should be understood that other designs and shapes of the vent slider may be possible so long as they can fit and be secured within the desired shape of the vent slider depression present on the top surface of the storage container lid.

The vent slider may have a top slider surface 915 and a bottom slider surface 920. The vent slider, being that the example embodiment has it rectangular in shape may also have a first side 922, a second side 924, a third side 926, and a fourth side 928. A vent slider side wall may be present that generally follows the perimeter of the vent slider along the first through fourth sides. The height of the vent side wall is generally consistent from the bottom surface of the vent slider to the top surface of the vent slider along the first side, second side and third side of the vent slider. However, the vent slider side wall may be larger on the fourth side of the vent slider. This is due to the presence of a first vent slider tab 930 and a second vent slider tab 935 that extend outward from and rises from the top surface of the vent slider. The vent slider tab may terminate at the fourth side of the vent slider where the vent slider side wall on the fourth side is the height from the bottom surface of the vent slider to the upper end of the vent slider tab. The vent slider tab may gradually curl upward and rise out of the top surface of the vent slider as the top surface of the vent slider approaches the fourth side of the vent slider. The vent slider tab is usable by the user to move the vent slider when it is in its positional attachment within the vent slider depression on the top surface of the storage container lid. The end user may use a finger or a thumb of the user's hand to push the vent slider by way of the vent slider tab in both the first direction and the second direction. By moving the vent slider in this manner, the user can control the amount of air, gas, or particles that may enter or leave the interior of the storage container base by way of the plurality of air opening present on the storage container lid. The amount of air, gas, or particles that may enter or leave the interior of the storage container base may be important depending on the food items or the prepared food products stored within the storage container base. For example, if fruits, vegetables, or other food items are stored within the storage container base and those fruits, vegetables, or other food items produce ethylene gas, it may be important to move the vent slider by way of the vent slider tab into the open position so that the ethylene gas can escape the interior of the storage container base. While ethylene gas is helpful for the general fruit and vegetable ripening process, the presence and continued contact with ethylene gas by fruits, vegetables, or other food items may hasten the ripening process leading to premature aging of the fruits, vegetables, or other food items severely limiting the usable shelf and storage life of such food items. Thus, venting in this manner is important for the storage container in the assembled configuration.

On the first and third sides of the vent slider, and present near the fourth side of the vent slider, a plurality of vent slider attachments 940 may be present. This plurality of vent slider attachments may include a first vent slider attachment 945 on the first side of the vent slider and a second vent slider attachment 950 on the third side of the vent slider. The first and second vent slider attachments are located on the first and third side sides of the vent slider on the lower portion of the vent slider side wall portion located on the first side and the third side. The first and second vent slider attachments are also located near the fourth side of the vent slider. Each the first vent slider attachment and the second vent slider may protrude outward from the vent slider side wall lower portion on the first side and the third side of the vent slider. When the vent slider is attached to the storage container lid, the first and second vent slider attachments are fit within the first and second vent slider openings that mirror each other with their locations on the left and right-side walls of the vent slider depression on the top surface of the storage container lid.

Also, the bottom surface of the vent slider may contain a slider lock 955. The vent slider lock is generally positioned near the second side of the vent slider but away from the termination point of the bottom surface of the vent slide at the second side. The vent slider lock may be an outward protrusion extending from the bottom surface of the vent slider. When the vent slider is attached within the vent slider depression on the storage container lid, the vent slider, by way of the vent slider lock, can move in the first direction and the second direction as desired by the user. Moving the vent slider in the first direction moves the vent slider lock from the first locking position present on the vent slider surface towards the second locking position present on the vent slider surface. Generally, the first locking position allows for air, gas, or particles to enter or leave the interior of the storage container base by way of the plurality of air openings present on the vent slider surface of the storage container lid. Also, the second locking position prevents air, gas, or particles to enter or leave the interior of the storage container base by way of the plurality of air openings present on the vent slider surface of the storage container lid as the second locking position placed the vent slider in a covering position over the plurality of air openings present on the vent slider surface.

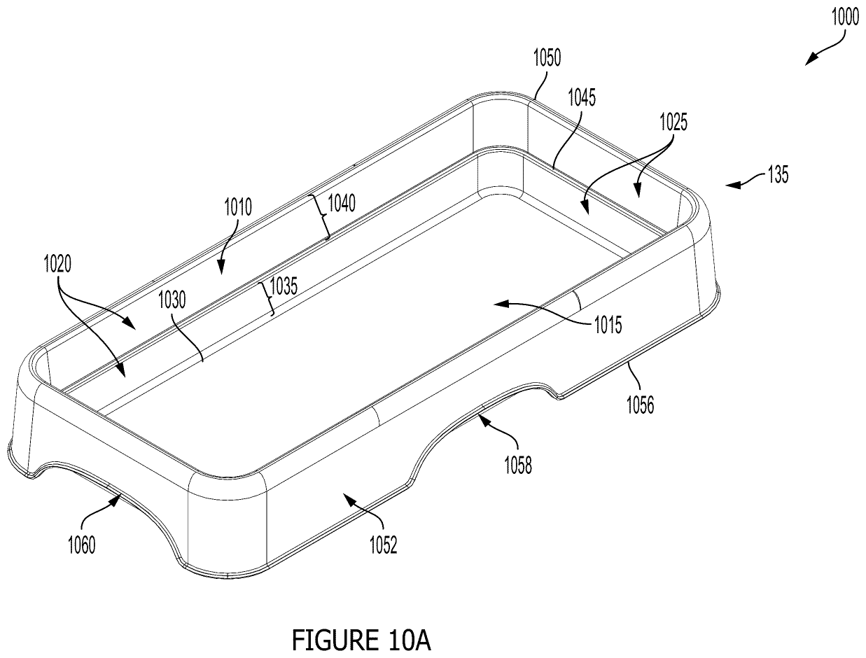

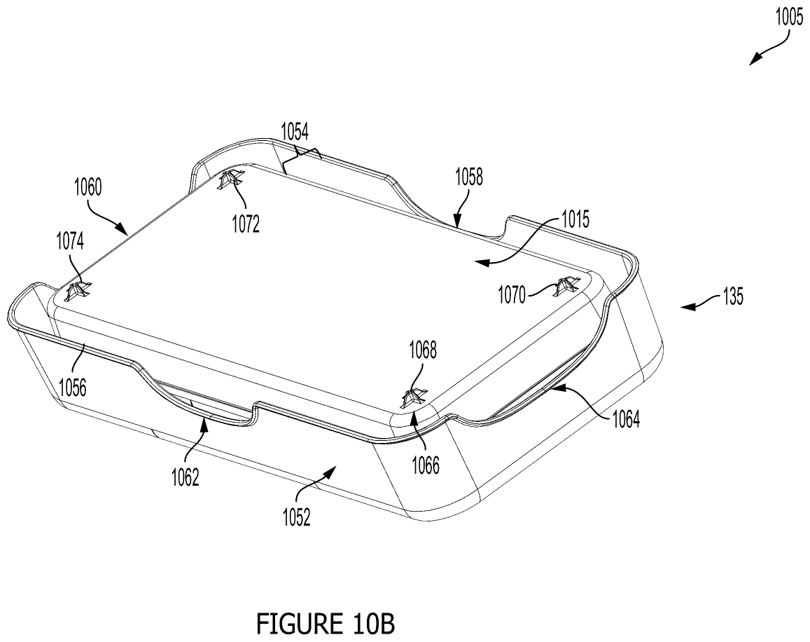

FIGS. 10A and 10B show a tray top-down perspective view 1000 (FIG. 10A) and a tray bottom-up perspective view 1005 (FIG. 10B) of a tray that may be used to contain a plurality of storage containers that may be part of the storage container assembly set in the assembled configuration. The tray may be created by any type of material suitable and safe to store food items or prepared food products although that is not a requirement. For example, the tray may be created with the use of food grade plastics, food grade polymer-based materials, or the like that are rated safe for food item or food product contact. The tray is envisioned to be continuous and may be made my mold injected material to create such a continuous design, but other manufacturing options are possible based on the configuration and materials used to create the tray. Additionally, the tray is envisioned to generally be constructed of dishwasher safe materials such that the tray can easily be washed within dishwashing machines for simple clean up and to remove any remaining food items or prepared food products after operational use. In other embodiments, the tray may be made out of food grade metals or metallic alloys or the like. For dry food use, the tray may also be created with wooden type materials, or other possible materials. Additionally, in some instances the tray may be created by a combination of materials. Further, the materials used to create the tray may have insulative properties or allow for easy containment and retention of thermal heating or cooling of objects placed into and contained within the tray to adjust or maintain the temperature of the food items or prepared food products held within the storage containers that may also be present and held within the tray. In some instances, only the bottom tray wall 1010 and interior tray side walls 1015 may be made of such thermal property material to help aid in the cooling, heating, or maintenance of temperature of any food items or prepared food products contained or stored within the storage containers present within the tray and in contact with the bottom or side walls of the tray. In yet other possible envisioned examples, the bottom and side walls of the tray may be made of the same material as the remaining portions of the tray, but may also contain a thermal coating on either or both the bottom surface or side wall surface to help aid in the cooling, heating, or maintenance of temperature of any food items or prepared food products contained or stored within the storage containers placed within and in contact with the bottom surface or side wall surface of the tray.

The tray viewed in FIGS. 10A and 10B is to be used with the storage container assembly set in an assembled configuration. The assembled configuration requires the presence of at least one assembled storage container within the tray. The tray of FIGS. 10A and 10B is able to hold a plurality of storage containers, with up to three assembled storage containers. In other assembled embodiments, a plurality of cooling inserts may also be present within the tray. The tray has an interior portion with a plurality of interior tray side walls 1015. As the tray of FIGS. 10A and 10B is rectangular in shape, the four interior tray side walls are present. The tray also contains a bottom tray wall 1010. The plurality of storage containers or the plurality of cooling inserts may rest within the interior of the tray on the bottom tray wall. As the tray is a rectangular shape, the first interior tray side wall 1020 and third interior tray side wall are generally the same shape. Correspondingly, the second interior tray side wall 1025 and fourth interior tray side wall are also generally the same shape. The connection 1030 between the bottom tray wall and each of the interior side walls is rounded. Each of the interior side walls then continue upward and angle outward from the position of the bottom tray wall.

The tray may also have a first interior tray area 1035 and a second interior tray area 1040. The second interior tray area may be larger than the first interior tray area. As viewed in FIGS. 10A and 10B, a side wall extension 1045 is present that approximately circumscribes the middle of the height of the plurality of interior tray side walls extend upward from the bottom tray side wall. In the first interior tray area, different components may be held. In one possible embodiment, a plurality of storage containers can fit and be contained within the first interior tray area. In another envisioned embodiment, a plurality of cooling inserts may be present and contained within the first interior tray area. In the second embodiment with the plurality of cooling inserts contained in the first interior tray area, the plurality of storage containers can then be placed within the interior of the tray and held within the second interior tray area on top of the plurality of cooling inserts.

The plurality of interior tray side walls travels upward until a tray top edge 1050 is reached. At the top edge, each of the plurality of interior tray side walls transition to a plurality of exterior tray side walls 1052 that then extend downward. The plurality of interior tray side walls are not the same as the plurality of exterior tray side walls. This configuration creates a tray space 1054 between the plurality of interior tray side walls and the plurality of exterior tray side walls that helps keep, maintain, and direct any thermal properties or temperatures within the interior of the tray with whatever components are housed within and to limit outside or unnecessary transfer. Like the plurality of interior tray side walls, the plurality of exterior tray side walls are generally continuous in nature. The plurality of exterior tray side walls extends downward and terminate a tray exterior lower edge 1056. The tray exterior lower edge is generally thicker than the plurality of interior tray side walls and the plurality of exterior tray side walls. The tray exterior lower edge allows the tray to securely rest on a surface as the tray is placed out for operational use.

The plurality of exterior tray side walls may each have a handhold location, being a first handhold location 1058, a second handhold location 1060, a third handhold location 1062, and a fourth handhold location 1064 on each respective exterior tray side wall. The handhold location is generally located at the bottom or lower section of the plurality of exterior tray side walls. The handhold locations are also generally present in the middle of the length of the associated exterior tray side wall where it may be present. The handhold locations are semicircular cut outs of the plurality of exterior tray side walls if they were to be ultimately extended to the surface contacting tray exterior lower edge. In use, the user can grab one or more of these handhold locations to move the tray and any contents contained inside. The presence of the handhold on each side of the tray design makes for easy grasping and then movement of the tray no matter the position in which the tray is stored.

On the bottom of the tray, a plurality of tray legs 1066, viewed in this example embodiment as a first tray leg 1068, a second tray leg 1070, a third tray leg 1072, and a fourth tray leg 1074, may be present. The bottom tray wall may not touch or contact the ultimate surface where the tray is positioned for use. Thus, to further support the tray and components contained within the interior of the tray, the plurality of tray legs may be present. The plurality of tray legs may be present on the bottom exterior surface of the bottom tray way. They may extend downward to a length that matches the ending length of the plurality of exterior tray side walls that extend downward and terminate at the tray exterior lower edge. In this manner, plurality of tray legs and the tray exterior lower edge both may contact the surface on which the tray rests and both support the tray. Further, the plurality of tray legs remove the bottom tray wall from contact with the surface so that thermal energy transfer may also not be lost to the surface on which the tray rests. Thus, more thermal energy available for transfer remains within the interior of the tray and is directionally directed at the components contained within the interior of the tray.

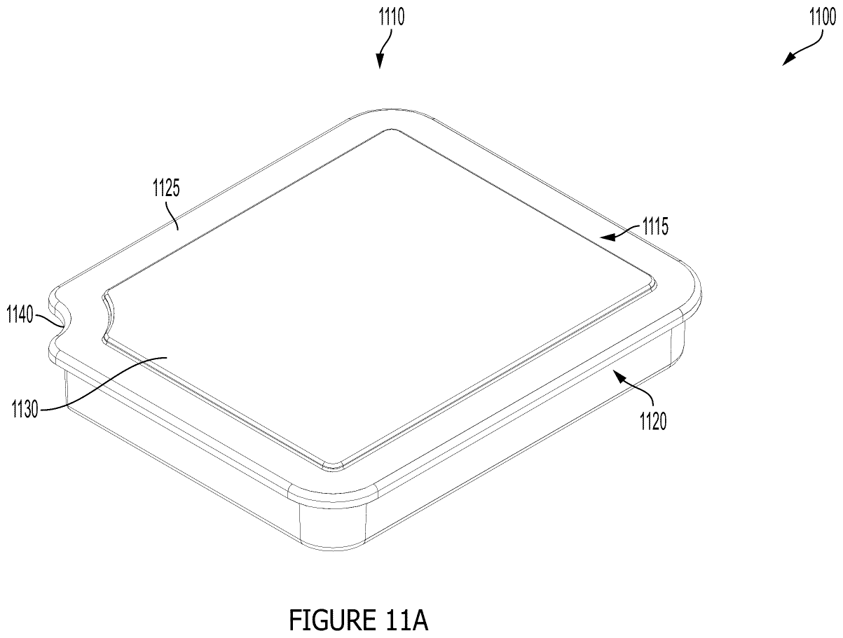

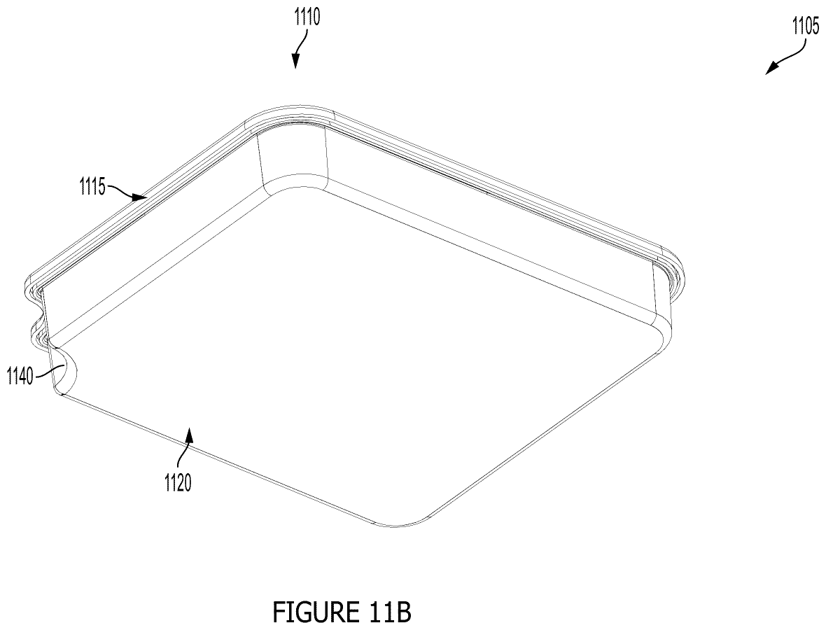

In FIGS. 11A and 11B, a insert top-down perspective view 1100 (FIG. 11A) and an insert bottom-up perspective view 1105 (FIG. 11B) of a cooling insert 1110 of the plurality of cooling inserts is shown that may be used with the tray that may be part of the storage container assembly set in the assembled configuration. The cooling insert may be created by any type of material suitable and safe to contact food items or prepared food products. The material or product used to create the cooling effect may not be food or food product safe. For example, the cooling insert may be created with the use of food grade plastics, food grade polymer-based materials, or the like that are rated safe for food items or food product contact. The cooling insert may be constructed of dishwasher safe materials such that the cooling insert can easily be washed within dishwashing machines for simple clean up and to remove any remaining food items or prepared food products after operational use. In other embodiments, the cooling insert may be made out of food grade metals or metallic alloys or the like. In most instances, the cooling insert may be created by a combination of materials. The internal components may not be food safe but may provide the necessary cooling effects desired. However, these internal components may be contained within a food safe material that cannot be opened. Further, the materials used to create the cooling insert will likely contain insulative properties or allow for easy transmission of thermal heating or cooling into the storage container base contacting the cooling insert to adjust or maintain the temperature of the food items or prepared food products held within the storage container base as desired by the end user. In some instances, only the top enclosure of the cooling insert may be made of such thermal properties to help aid in the cooling, heating, or maintenance of temperature of any food items or prepared food products contained or stored within the storage container base and in contact with the cooling insert. In yet other possible envisioned examples, the top surface of the cooling insert may be made of the same material as the remaining portions of the storage container base, but may also contain a thermal coating on either or both the interior surface and or exterior surface of the top portion of the cooling insert to help aid in the cooling, heating, or maintenance of temperature of any food items or prepared food products contained or stored within the storage container base and in contact with the cooling insert.

As viewed in FIGS. 11A and 11B, a cooling insert may be present as part of a plurality of cooling inserts. The cooling insert may have a top lid 1115 and a bottom container 1120. Within the bottom container, the cooling insert may be filled with a liquid solution, chemical gel, or the like that can take on specific thermal properties. While the cooling insert is generally envisioned for use with the tray and the storage containers to keep food items and prepared food products cool outside of refrigerated conditions, it should also be understood that the cooling insert could also be used with heat producing and retentive materials to keep food items and prepared food products warm outside of general heating conditions. Once the liquid solution, chemical gel, or the like fills the bottom container of the cooling insert the top's lid of the cooling insert may attach and be secured to the bottom container. It is generally advisable that once the cooling insert is assembled in this manner, it is not to be disassembled due to the possible toxic nature of the liquid solution, chemical gel, or the like that may be contained within the cooling insert. Usually the liquid solution, chemical gel, or the like is reusable in some fashion. Thus, after assembly, the cooling insert may be placed into the refrigerator or freezer to set at the desired temperature to provide the most optimal cooling when used with the tray and the plurality of storage containers in the storage container assembly set in the assembled configuration. In the assembled configuration, the plurality of cooling inserts may transfer cooling energy to the contacted storage containers of the plurality of storage containers. This contact allows for the cooling energy transfer from the plurality of cooling inserts to the plurality of storage containers through each storage container bottom surface. This in turn may cool or help maintain a cooler temperature of possible ambient air sealed within a respective storage container in contact with the plurality of cooling inserts or to cool the food items or prepared food products contacting the bottom wall of the storage container base.

The cooling inserts are generally larger in size and surface area than a respective storage container when it is assembled. In the assembled configuration, a plurality of cooling inserts may be used. When chosen for use, the plurality of cooling inserts can rest and nest within the interior of the tray and be bounded by the interior side walls of the tray. Once placed in this position, the plurality of storage containers in either an assembled form or solely the plurality of storage container bases may also be placed into the tray. A plurality of surface legs may generally be present and extend downward from each storage container base of the plurality of storage container bases or the assembled plurality of storage containers. The plurality of surface legs on each storage container are used to help guide the storage container into the correct resting position on any contacted cooling insert that may be present within the tray. Each cooling insert of the plurality of cooling inserts may have a first top surface 1125 and a second top surface 1130 on each cooling insert. The first top surface 1125 is viewed and envisioned to be slightly lower than the second top surface on each cooling insert. Further, the first top surface of the cooling insert may circumnavigate and surround the second top surface of the cooling insert while creating the top edge of the cooling insert. Both the first top surface and the second top surface are generally flat and planer designs, but other possible configurations are envisioned. As stated above, the second top surface of the cooling insert is higher than the first top surface of the cooling insert. When the plurality of storage containers or the plurality of storage container bases are to be placed within the tray already holding the plurality of cooling inserts, the differentiation between the first top surface and the second top surface of each respective cooling insert has additional importance. The plurality of surface legs that may be present on each storage container base, whether alone or as an assembled storage container, may rest and contact the first top surface of the plurality of cooling insert. It should be understood and appreciated that the plurality of cooling inserts used and secured within the tray are to have common locations of their respective first top surface and second top surface. While the plurality of surface legs contact the first top surface of any cooling insert based on placement within the tray, the base exterior surface of the storage container base contacts and may rest upon the second top surface of the any respective cooling insert. This contact between the second top surface of the plurality of cooling inserts and exterior bottom surface of any of the plurality of storage container bases allows for the most optimal and ideal amount of cooling energy transfer between the cool, cold, or frozen plurality of cooling inserts and whatever food item or prepared food products are housed within the plurality of storage container bases. Moreover, when the plurality of surface legs of any storage container base contacts the first top surface of any cooling insert placed within the tray, movement is minimized. As the length, width, and surface area of first top surface of the cooling insert is much smaller than the length, width, and surface area of the second top surface of the cooling insert, the first top surface can be thought of as a small channel. Placement of the plurality of surface legs of any storage container base on the top surface may allow for slight minimal movement in a width direction but the presence of the plurality of surface legs bounds and confines any storage container on width movement by the second surface of the cooling insert on one end and the interior side wall of the tray on the other end. Thus, the storage container base is relatively secure when placed inside the tray where the exterior bottom surface of the storage container maintains maximum contact with the second top surface of the cooling inserts upon which it may rest.

Further, while movement in the width direction of the storage container base may be bounded in the width direction when placed with the tray in the assembled configuration of the storage container assembly set, lengthwise movement of the storage container base is possible based on the common configuration and envisioned design of each first top surface and second top surface of the cooling inserts that are used to create the plurality of cooling inserts. When assembling the storage container assembly set, a first storage container base either alone or as an assembled storage container may be first placed within the tray to rest on the plurality of cooling inserts. Often times, the end user may want to adjust or reconfigure the positioning of the storage container base when additional components such as a second or third storage container base is added to the storage container assembly set and placed within the tray in the assembled position. Thus, the end user can manually slide the storage container base first placed within the tray and resting on the plurality of storage container inserts to the desires position lengthwise. While sliding the storage container base first placed within the tray, the storage container base can move with its plurality of surface legs along the first top surface of any cooling insert it may contact while allowing the bottom exterior surface of the storage container base to remain in contact with a plurality of cooling inserts to keep and maintain the cooling energy transfer that may be needed for the food items or prepared food products present within the storage container base.

Finally, an insert corner 1140 of each cooling insert may not have a generally rounded design. This corner of the cooling insert may have a semicircular portion appearing to be absent in the overall design, but the cooling insert lid is designed to match a similar cooling insert bottom portion. This absent corner in the semicircular configuration allows for the user to grasp and quickly remove and place the cooling inserts into the appropriate positions within the tray of the storage container assembly set as needed. After use, this absent corner in the semicircular configuration allows the user to quickly grasp and remove the cooling inserts from the tray so that they can be cooled or frozen again for future use.

The embodiments were chosen and described in order to best explain the principles of the invention and its practical application to thereby enable others skilled in the art to best utilize the invention in various embodiments and with various modifications as are suited to the particular use contemplated.

As various modifications could be made in the construction and method herein described and illustrated without departing from the scope of the invention, it is intended that all matter contained in the foregoing description or shown in the accompanying drawings shall be interpreted as illustrative rather than limiting. For example, the design of the storage container assembly set overall, the storage container bases, the drainage shelf, and different types of cooling inserts may be employed but can achieve the same functionality of the underlying invention. Thus, the breadth and scope of the present invention should not be limited by any of the above-described example embodiments but should be defined only in accordance with the following claims appended hereto and their equivalents.

What is claimed is:

1. A storage container assembly comprising:
a tray having a tray interior;
a plurality of storage container bases;
a plurality of storage container lids, the plurality of storage container lids having a plurality of venting holes through a lid surface and adapted and configured to allow for air to flow into and out of the storage container;
wherein a storage container lid of the plurality of storage container lids is adapted to couple with a storage container base of the plurality of storage container bases to create an assembled configuration of a storage container of a plurality of storage containers; and
wherein the tray being adapted and configurated to hold one or more storage containers within the tray interior.

2. The storage container assembly of claim 1, wherein each storage container lid of the plurality of storage container lids has a vent slider, the vent slider being moveable in a first direction and a second direction to control airflow into and out of the storage container.

3. The storage container assembly of claim 2 further comprising a plurality of cooling inserts, the plurality of cooling inserts being removably positioned within the tray interior, the plurality of cooling inserts being adapted and configured to receive or transmit thermal energy.

4. The storage container assembly of claim 3 wherein the tray interior has a first tray interior and a second tray interior, and wherein the plurality of cooling inserts are removably positioned in the first tray interior.

5. The storage container of claim 3, further comprising a drainage shelf, the drainage shelf being removably insertable within a storage container base of the plurality of storage containers.

6. The storage container of claim 5, wherein the drainage shelf comprises and rests upon at least one drainage shelf legs.

7. The storage container assembly of claim 1 wherein each of the plurality of lids are adapted and configured to nest within and stack upon another of the plurality of lids when the storage container assembly is in a disassembled configuration.

8. The storage container assembly of claim 1 wherein each of the plurality of storage container bases are adapted and configured to nest within and stack upon another of the plurality of storage container bases when the storage container assembly is in a disassembled configuration.

9. The storage container assembly of claim 2 wherein each of the plurality of lids further comprise a sealing mechanism, the sealing mechanism being adapted and configured to facilitate the creation of a vacuum seal between the assembled configuration of the storage container and ambient air.

10. The storage container assembly of claim 2, wherein each of the plurality of storage container bases comprise a at least one surface leg, the at least one surface leg being adapted and configured to space each of the plurality of storage container bases from the tray.

11. The storage container assembly of claim 10, wherein the at least one surface leg comprises a plurality of surface legs.

12. The storage container assembly of claim 1 wherein the tray is adapted and configured to train at least three storage containers in the assembled configuration.

13. A storage container comprising:
A storage container base;
a storage container lid, the storage container lid being operably and removably coupled with the storage container base when in an assembled configuration;
a plurality of venting holes present on the storage container lid, each of the plurality of venting holes being adapted and configured to allow air to flow into and out of the storage container in the assembled configuration.

14. The storage container of claim 13, wherein the storage container base further comprises at least one surface leg, the at least one surface leg adapted and configured to space the storage container base from a surface.

15. The storage container of claim 13, further comprising a drainage shelf, the drainage shelf being removably insertable within the storage container base.

16. The storage container of claim 15, wherein the drainage shelf comprises and rests upon a plurality of drainage shelf legs.

17. A method for assembling a storage container set, the method comprising:
inserting a plurality of cooling inserts into a tray;
forming a first storage container by coupling a lid from a plurality of lids with a base of a plurality of bases to create an assembled configuration of a storage container;
inserting a first storage container into the tray such that the first storage container contacts at least one of the plurality of cooling inserts.

18. The method of claim 17, further comprising:
forming a second storage container by coupling a second lid from a plurality of lids with a second base of a plurality of bases to create a second storage container in the assembled configuration;
inserting the second storage container into the tray such that the second storage container contacts at least one of the plurality of cooling inserts.

19. The method of claim 17, further comprising:
forming a third storage container by coupling a third lid from a plurality of lids with a base of a plurality of bases to create a third storage container in the assembled configuration;
inserting the third storage container into the tray such that the third storage container contacts at least one of the plurality of cooling inserts.

20. The method of claim 19, further comprising:
inserting a drainage tray within the base of one of the first, second, or third storage containers.
